(19) United States
(12) Patent Application Publication
(10) Pub. No.: US 2014/0235744 A1
(43) Pub. Date: Aug. 21, 2014

(54) PROCESS FOR PRODUCING NITRILE RUBBERS IN ORGANIC SOLVENTS

(71) Applicants: Sven Brandau, Strasbourg (FR); Andreas Kaiser, Strasbourg (FR); Michael Klimpel, Langenfeld (DE); Christopher Barner-Kowollik, Stutensee-Blankenloch (DE); Christoph Duerr, Karlsruhe (DE); Sebastian Emmerling, Leimersheim (DE)

(72) Inventors: Sven Brandau, Strasbourg (FR); Andreas Kaiser, Strasbourg (FR); Michael Klimpel, Langenfeld (DE); Christopher Barner-Kowollik, Stutensee-Blankenloch (DE); Christoph Duerr, Karlsruhe (DE); Sebastian Emmerling, Leimersheim (DE)

(73) Assignee: LANXESS DEUTSCHLAND GMBH, Cologne (DE)

(21) Appl. No.: 14/235,551

(22) PCT Filed: Aug. 1, 2012
(86) PCT No.: PCT/EP2012/064989

§ 371 Date: Apr. 4, 2014

(30) Foreign Application Priority Data
Aug. 2, 2011 (EP) 11290355.4

(51) Int. Cl. C08F 2/38

(52) U.S. Cl. CPC C08F 2/38
USPC 522/151; 526/219.3; 525/55

(57) ABSTRACT

A novel and improved process is provided for producing nitrile rubbers through free-radical polymerization in specific solvent mixtures. The resultant nitrile rubbers can then be subjected to hydrogenation. The process features excellent time-conversion curves.

The present invention relates to a process for producing nitrile rubbers through free-radical polymerization, which is carried out in solution by combining certain solvents, and to a process for hydrogenating the resultant nitrile rubbers.

Nitrile rubbers, also abbreviated to “NBR”, are rubbers involving co- or terpolymers of at least one α,β-unsaturated nitrile, of at least one conjugated diene and optionally of one or more other copolymerizable monomers. Hydrogenated nitrile rubbers (“HNBR”) are corresponding co- or terpolymers in which the C═C double bonds of the copolymerized diene units have been fully or partially hydrogenated.

Both NBR and HNBR have for many years occupied a secure position in the sector of speciality elastomers. They have an excellent property profile in the form of excellent oil resistance, good heat resistance and outstanding resistance to ozone and chemicals, and this latter resistance is even higher for HNBR than for NBR. Furthermore, they have very good mechanical properties, and also good performance characteristics. They are therefore widely used in a very wide variety of application sectors, and by way of example are used for producing gaskets, hoses, drive belts and damping elements in the automobile sector, and also for stators, borehole seals and valve seals in the oil-production sector, and also for numerous components in the electrical industry, and in mechanical engineering and shipbuilding. There is a wide variety of commercially available types, and these feature different monomers, molar masses, polydispersities, and mechanical and physical properties, as a function of application sector. In particular, there is increasing demand not only for the standard types but also specialty types comprising specific termonomer contents or particular functionalizations.

Another factor of increasing importance in the practical use of the (H)NBR rubbers is the vulcanization of the rubbers, i.e. in particular the crosslinking agent system and the vulcanization conditions. By way of example, various novel systems for alternative crosslinking have been developed in recent years, alongside the existing traditional rubber crosslinking systems which have already been known for many decades and which are based on peroxides/sulphur. Crosslinking systems of this type also include polymers which by virtue of functional groups are not accessible to every type of crosslinking and every crosslinking agent and which therefore provide a particular challenge.

Industrial production of nitrile rubbers proceeds almost exclusively through what is known as emulsion polymerization. This process usually uses dodecyl mercaptans, in particular tertiary dodecyl mercaptans (abbreviated to “TDDM” or else “TDM”) to regulate molar mass and thus also to regulate the viscosity of the resultant nitrite rubber. After polymerization, the resultant NBR latex is coagulated in a first step, and the solid NBR is isolated therefrom. Insofar as subsequent hydrogenation of the nitrile rubber to give HNBR is desired, the said hydrogenation likewise uses known prior-art methods, for example with use of homogeneous or else heterogeneous hydrogenation catalysts. The catalysts are usually based on rhodium, ruthenium or titanium. However, it is also possible to use platinum, iridium, palladium, rhenium, ruthenium, osmium, cobalt or copper either as metal or else preferably in the form of metal compounds.

If these hydrogenation reactions of NBR to give HNBR are carried out on an industrial scale, they are usually carried out in a homogeneous phase, i.e. in an organic solvent. Suitable catalysts and solvents here are known by way of example from DE-A 25 39 132 and EP-A 0 471 250. The material known as Wilkinson catalyst has in particular proved successful for selective hydrogenation of nitrile rubbers in monochlorobenzene as organic solvent. In order that the said hydrogenation can be carried out in an organic medium, the nitric rubber obtained in aqueous emulsion after the polymerization process must firstly be isolated. This requires complicated process technology and apparatus, and is therefore not very economically attractive.

An additional factor is that during the course of hydrogenation of nitrile rubbers a quite considerable rise (known as the Mooney Increase Ratio (“MIR”)) occurs in viscosity (usually by a factor of 2 or more). For this reason, it is sometimes necessary, prior to hydrogenation, to subject nitrile rubbers to molar-mass degradation (e.g. through metathesis) in another step, so that it is finally possible to obtain a hydrogenated nitrile rubber which does not have excessively high molar mass, or does not have excessively high viscosity. The synthesis routes that are known hitherto and that can be used industrially also place certain limits on the possibilities for influencing polydispersity.

There have previously been many different approaches to optimization of the production processes for NBR and HNBR. By way of example, attempts have been made to carry out the polymerization to give the nitrile rubber in organic solution. However, this work has hitherto appeared unlikely to lead to much success, and no actual industrial implementation of processes of that type is so far known either from the literature or in practice. In the abstract of the Dissertation by C. Hollbeck, Universitat-Gesamthochschule Essen, 1995, page II, the following is said concerning the copolymerization of acrylonitrile and 1,3-butadiene in organic solvent (quotation): “with a number-average degree of polymerization Pn of 1589 (molar mass (Mn)=˜85 800 g/mol) and with a conversion of 40.5%, the objectives set were realized in 40 hours at a reaction temperature of 343 K. A reduction in time to 18 hours was possible only if the required conversion was reduced. Trials have shown that a combination of Pn≧1400 and conversion greater than 40% is not within the realm of the possible under the present conditions even when the temperature is increased to 353 K”. If achievable conversion is restricted to just over 40% within a reaction time of 40 hours, the organic solution polymerization process described in that document is of no practical use, technically or economically.

The technology known as RAFT has already been used in the prior art for the synthesis of various polymers (WO-A-01/60792, U.S. Pat. No. 7,230,063 B1, WO-A-2007/003782, US-A-2008/0153982, WO-A-2005/061555).

WO-A-98/01478 describes the production of a very wide variety of homo- and copolymers. Examples of homopolymers synthesized are poly(meth)acrylates, poly(meth)acrylic acid, polyacrylamides and polystyrene. Examples of block copolymers produced are poly(methyl acrylate-block-ethyl acrylate), poly(n-butyl acrylate-block-acrylic acid), poly(4-methylstyrene-block-styrene), poly(styrene-block-acrylamide), poly(methyl methacrylate-block-styrene), poly(acrylonitrile-co-styrene) (Example 67), poly(styrene-co-butadiene) (Example 69) and others. However, the possibility of copolymerizing a conjugated diene, in particular 1,3-butadiene, with an α,β-unsaturated nitrile, in particular acrylonitrile, is neither described in nor obvious from WO-A-98/01478.

It is already known that RAFT technology can be used to produce pure polyacrylonitrile (PAN). Macromolecules 2003, 36, 8537 discloses first attempts, which gave polyacrylonitrile with only small molar masses of up to 16 000 g/mol and with narrow molecular-weight distributions close to 1.1. Since then, further work has been carried out which gave useful results in producing polyacrylonitrile through RAFT polymerization. This process is described inter alia in European Polymer Journal (2008), 44(4), 1200-1208 (Xiao-hui Liu, Gui-bao Zhang, Bai-xiang Li, Yun-gang Bai, Ding Pan and Yue-sheng Li). Here, it was possible to use RAFT technology to obtain polyacrylonitrile with high molar mass (Mn>200 000 g/mol) and with low polydispersity index (PDI˜1.7) in solution with use of bis(thiobenzoyl) disulphide or bis(thiophenylacetoyl) disulphide, as precursors for the regulators 2-cyanoprop-2-yl dithiobenzoate and 2-cyanoprop-2-yl clithiophenylacetate generated in situ. As described in Journal of Polymer Science, Part A: Polymer Chemistry (2005), 44(1), 490-498, the use of dibenzyl trithiocarbonates as RAFT regulators for the homopolymerization of acrylonitrile leads, in contrast, only to polymers with low molar masses (MO of <30 000 g/mol, even if the polydispersities are from 1.02 to 2.35. Macromolecular Chemistry and Physics (2002), 203(3), 522-537 moreover discloses that the homopolymerization of 1,3-butadiene through RAFT technology gives only polymers with low molar masses: the molar masses (Mₙ) achieved are even lower than in the abovementioned production of polyacrylonitrile using dibenzyl trithiocarbonates as RAFT regulators, and are at most 10 500 g/mol, while polydispersity is simultaneously high: 3.40. Although it is also possible here to obtain markedly lower polydispersities extending as far as 1.24, this is possible only with substantial sacrifices in terms of molar mass (Mₙ) down to as little as 1300 g/mol.

WO-A-2011/032832 described for the first time a process for producing nitrile rubbers through polymerization in organic solution. One or more organic solvents can be used here. The said process is carried out in the presence of specific “RAFT” regulators, WO2012/028501A and WO2012/028503A moreover describe the production of nitrile rubbers in organic solution in the absence of any regulator or in the presence of specific regulators, e.g. mercaptans, mercapto alcohols, mercaptocarboxylic acids, thiocarboxylic acids, disulphides, polysulphides, thiourea and others. It was not expected that the use of “RAFT” regulators would be successful in NBR polymerization, in particular in the light of the studies described above relating to production of polybutadiene (Macromolecular Chemistry and Physics (2002), 203(3), 522-537), which only give molar masses of orders of magnitude that are of no interest industrially (industrially useful butadiene-based polymers generally require a molar mass Mn>50 000 g/mol, and the same applies to random copolymers based on acrylonitrile and butadiene). However, the process described in WO-A-2011/032832 is not yet ideal in respect of the time-conversion performance of the polymerization process to give the nitrile rubber.

GB1,005,988 describes polymerization of conjugated dienes through free-radical polymerization in an organic solvent. The solvent here can comprise from 1 to 20% of extender oil. Homopolymerization of butadiene in benzene, of isoprene in pentane, and of isoprene in hexane is described.

Against the background described above, the object of the present invention therefore consisted in providing an improved process for producing nitrile rubbers in organic solution.

Surprisingly, it has been found that use of certain solvent mixtures in certain ratios in the production of a nitrile rubber can, in comparison with a pure solvent, achieve an increase in monomer conversion as a function of time,

For the purposes of this application, the expression “nitrite rubber(s)” is to be interpreted broadly, and comprises not only nitrite rubbers but also hydrogenated nitrile rubbers. To the extent that hydrogenated nitrile rubbers are involved, the wording “nitrile rubbers comprising repeat units derived from” therefore means that the repeat units based on the conjugated diene involve units in which the C═C double bonds initially present in the polymer after the polymerization process have been fully or partially hydrogenated.

To the extent that this application uses the expression “substituted”, this means that a hydrogen atom on a stated moiety or atom has been replaced by one of the stated groups, with the proviso that the valency of the stated atom is not exceeded and always on condition that the said substitution leads to a stable compound.

The invention therefore provides a process for producing nitrile rubbers through free-radical polymerization of at least one conjugated diene, of at least one α,β-unsaturated nitrile and optionally of one or more other copolymerizable monomers, which is characterized in that at least two solvents are used, where the amount used of one solvent is in the range from 70 to 99.9% by volume, based on the entirety of all of the solvents used.

The process according to the invention can be carried out in various embodiments,

(1) in the absence of any molar-mass regulator,
(2) in the presence of a compound of the general structural formula (VI)

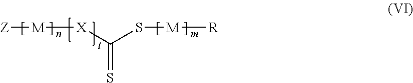

in which
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
R (a) if m≠0, has the same meanings as the moiety Z and
   (b) if m=0, is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0, and
X is C(Z₂), N(Z), P(Z), P(═O)(Z), O, S, S(═O) or S(═O)₂, where Z in these moieties can have the meanings stated previously for the formula (VI),
   or
   (3) in the presence of a compound selected from the group consisting of
(i) mercaptans which comprise at least one SH group,
(ii) mercapto alcohols which comprise at least one SH group and at least one OH group,
(iii) memaptocarboxylic acids which comprise at least one SH group and at least one carboxy group, and mercaptocarboxylic esters which comprise at least one SH group and at least one carboxylic ester group,
(iv) thiocarboxylic acids,
(v) disulphides, polysulphides,
(vi) thiourea,
(vii) allyl compounds,
(viii) aldehydes,
(ix) aliphatic halohydrocarbons, araliphatic halohydrocarbons and
(x) saccharin and
(xi) any desired mixtures of two or more of the abovementioned molar-mass regulators (i)-(x).

The process according to the invention, through the use of at least two solvents, succeeds in achieving a significant conversion increase for identical reaction times, when comparison is made with the sole use of the solvent of which at least 70% by volume, based on the entirety of all of the solvents, is used in the process according to the invention. This accordingly means that conversions similar to those achieved when using just the one solvent can now be achieved in less reaction time. The use of a solvent mixture in the specific composition has no adverse effect on the resultant molar masses. Industrially acceptable molar masses (Mn>50 000 g/mol) can therefore be achieved with—in comparison with conventional emulsion NBR—very low polydispersities of markedly less than 2.0.

The free-radical polymerization in the process according to the invention is optionally followed by hydrogenation of the nitrile rubber to give fully or partially hydrogenated nitrile rubber.

### DETAILED DESCRIPTION

### Embodiment (2) of the Process According to the Invention

Embodiment (2) of the process according to the invention uses at least one regulator of the general formula (VI) previously specified.

The meanings specified for the moieties Z and R of the general formula (VI) can respectively have mono- or polysubstitution. It is preferable that the following moieties have mono- or polysubstitution: alkyl, carbocyclyl, heterocyclyl, aryl, heteroaryl, arylalkyl, heteroarylalkyl, alkoxy, aryloxy, alkylthio, arylthio, amino, amido, carbamoyl, phosphonato, phosphinato, sulphanyl, thiocarboxy, sulphinyl, sulphono, sulphino, sulpheno, sulphamoyl, silyl, silyloxy, carbonyl, carboxy, oxycarbonyl, oxysulphonyl, oxo, thioxo, borates, selenates and epoxy.

Substituents that can in turn be used—to the extent that the results are chemically stable compounds—are any of the meanings that Z can assume. Particularly suitable substituents are halogen, preferably fluorine, chlorine, bromine or iodine, nitrile (CN) and carboxy.

The meanings specified for Z and R in the general formula (VI) also explicitly include salts of the moieties specified, to the extent that these are chemically possible and stable. Those involved here can by way of example be ammonium salts, alkali metal salts, alkaline earth metal salts, aluminium salts or protonated forms of the regulators of the general formula (VI).

The meanings specified for Z and R in the general formula (VI) also include organometallic moieties, for example those which provide a Grignard function to the regulator. Z and R can moreover be, or comprise, a carbanion, with lithium, zinc, tin, aluminium, lead and boron as counterion.

It is moreover possible that the regulator has coupling by way of the moiety R via a linker to a solid phase or support substance. The linker can involve one of the following linkers known to the person skilled in the art: Wang, Sasrin, or Rink acid, or 2-chlorotrityl, Mannich, safety-catch, traceless or photolabile linkers. Examples of solid phases or support substances that can be used are silica, ion-exchanger resins, clay, montmorillonite, crosslinked polystyrene, polyethylene glycol grafted onto polystyrene, polyacrylamides (“Pepsyn”), polyethylene glycol-acrylamide copolymers (PEGA), cellulose, cotton and granulated porous glass (CPG, controlled pore glass).

It is moreover possible that the regulators of the general formula (VI) function as ligands for organometallic complex compounds, for example for those based on the following central metals: rhodium, ruthenium, titanium, platinum, iridium, palladium, rhenium, osmium, cobalt, iron or copper.

The meanings listed for the moiety “M” in the abovementioned general formula (VI) can have mono- or polysubstitution. M can therefore involve repeat units of one or more, mono- or polyunsaturated monomers, and preferably optionally can involve mono- or polysubstituted conjugated or non-conjugated dienes, or optionally mono- or polysubstituted alkynes or optionally mono- or polysubstituted vinyl compounds, for example fluorinated mono- or polyunsaturated vinyl compounds, or else can involve a divalent structural element which derives from substituted or unsubstituted polymers comprising polyethers, in particular polyalkylene glycol ethers and polyalkylene oxides, polysiloxanes, polyols, polycarbonates, polyurethanes, polyisocyanates, polysaccharides, polyesters and polyamides. Behind these moieties “M” there may therefore lie a monomeric or polymeric moiety.

It is preferable to use a regulator of the general formula (VI) in which
Z has the meanings previously specified for the general formula (VI)
R has the meanings previously specified for the general formula (VI) in the variant b) where m=0 and
n, m and t are all equal to zero.

The said preferred regulator therefore has the general structure (VIa)

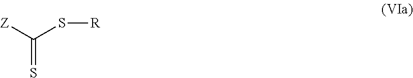

in which
Z has the meanings previously specified for the general formula (VI) and
R has the meanings previously specified for the general formula (VI) in the variant b) where m=0.

### Trithiocarbonates:

Another preferred regulator that can be used comprises a regulator of the general formula (VIb),

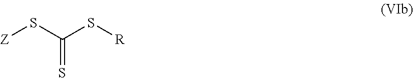

in which
Z has the meanings previously specified for the general formula (VI),
R has the meanings previously specified for the general formula (VI) for the variant b) where m=0 but with the restriction that, after homolytic cleavage of the S—R bond, R forms either a secondary, tertiary or aromatically stabilized free radical.

This particularly preferred regulator of the general formula (VIb) derives from the regulator of the general formula (VI) in that
n and m are respectively=0,
t is equal to 1,
X is sulphur,
Z has the meanings previously specified for the general formula (VI) and
R has the meanings previously specified for the general formula (VI) for the variant b) where m=0, but with the restriction that, after homolytic cleavage of the S—R bond, R forms either a secondary, tertiary or aromatically stabilized free radical.

These particularly preferred regulators of the general formula (VIb) therefore involve, as a function of whether Z and R within the context of the prescribed meanings are identical or not, symmetrical or asymmetrical trithiocarbonates.

Particular preference is given to using a regulator of the general formula (VIb) in which
Z has the meanings previously specified for the general formula (VI) and
R, with the proviso that, after homolytic cleavage of the S—R bond, R forms either a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or mono- or polyunsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

It is also particularly preferable to use a regulator of the general formula (VIb) in which
Z has the meanings previously specified for the general formula (VI), but likewise with the additional restriction to meanings such that, after homolytic cleavage of the Z—S bond, Z forms either a secondary, tertiary or aromatically stabilized free radical.

A trithiocarbonate regulator is then involved here in which the two moieties R and Z have polymerization-initiating effect.

It is also very particularly preferable to use a regulator of the general formula (VIII) in which
R and Z are identical or different and, with the proviso that, after homolytic cleavage of the R—S and, respectively, Z—S bond, R and Z respectively form a secondary, tertiary or aromatically stabilized free radical,
   are a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   are a saturated or mono- or polyunsaturated, optionally mono- or polysubstituted carbocyclyl or heterocyclyl moiety, in particular cyclohexyl, cumyl or cyclohexane-1-nitrile-1-yl,
   are a (hetero)aryl moiety, very particularly preferably a C₆-C₂₄-(hetero)aryl moiety, in particular phenyl, pyridinyl or anthracenyl,
   are a (hetero)aralkyl moiety, very particularly preferably benzyl, phenylethyl or 1-methyl-1-phenyleth-2-yl, or
   are thiocarboxy, carbonyl, carboxy, oxo, thioxo, epoxy, or else a salt of the abovementioned compounds.

In relation to the wordings used for the general formula (VIb) and hereinafter for the general formulae (VIc), (VId) and (VIe) “that, after homolytic cleavage of the R—S bond, R forms a secondary or tertiary free radical”, the definitions below are applicable. These also apply in analogous form for the corresponding wording “that, after homolytic cleavage of the Z—S bond. Z forms a secondary or tertiary free radical”, to the extent that this is used in connection with Z in the context of the application.

The atom in the moiety R that produces the bond to S in the general formula (VIb) (and, respectively, in the subsequent general formulae (VIc), (VId) and (VIe)) then leads, on homolytic cleavage of the R—S bond, to a free radical which is referred to as “tertiary” when this atom has attached to it (with the exception of the bond to the sulphur) at least

(i) three substituents via single bonds, or
(ii) one substituent via a single bond and a further substituent via a double bond, or
(iii) one substituent via a triple bond,
all of the abovementioned substituents necessarily being other than hydrogen.

The atom in the moiety R that produces the bond to S in the general formulae (VIb), (VIc), (VId) and (VIe) then leads, on homolytic cleavage of the R—S bond, to a free radical identified as being “secondary”, when attached to said atom there

(i) are two substituents via single bonds or
(ii) is one substituent via a double bond,
it being necessary for all of the abovementioned substituents to be other than hydrogen, and all other possible substituents being H.

Examples of moieties R or Z which on homolytic cleavage of the R—S(or Z—S) bond result in a free radical referred to as “tertiary” are tert-butyl, cyclohexane-1-nitrile-1-yl and 2-methylpropanenitrile-2-yl.

Examples of moieties R or Z which on homolytic cleavage of the R—S(or Z—S) bond result in a free radical referred to as “secondary” are sec-butyl, isopropyl and cycloalkyl, preferably cyclohexyl.

In relation to the proviso used hereinafter for the formula (VId) “that, after homolytic cleavage of the Z—S bond, Z forms a primary free radical”, the following definition is applicable: the atom in the moiety Z that produces the bond to S in the general formula (VId) then leads, on homolytic cleavage of the Z—S bond, to a free radical which is referred to as “primary” when this atom has no, or at most one, non-hydrogen substituent attached to it via a single bond. Compliance with the abovementioned proviso is regarded as achieved by definition if Z═H.

Examples of moieties Z which result, on homolytic cleavage of the Z—S bond, in a free radical referred to as “primary” are, therefore, H, linear C₁-C₂₀ alkyl moieties, OH, SH, SR and C₂-C₂₀ alkyl moieties with branches beyond the C atom that produces the bond to S.

### Dithioesters:

Another preferred regulator that can be used comprises a regulator of the general formula (VIc),

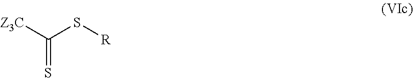

in which
has the meanings previously specified for the general formula (VI),
R has the meanings previously specified for the general formula (VI) for the variant b) where m=0 but with the restriction that, after homolytic cleavage of the S—R bond, R forms either a secondary, tertiary or aromatically stabilized free radical.

This particularly preferred regulator of the general formula (VIc) derives from the regulator of the general formula (VI), where
n and m are respectively=0,
t is equal to 1,
X is C(Z)₂,
Z has the meanings previously specified for the general formula (VI) and
R has the meanings previously specified for the general formula (VI) for the variant b) where m=0, but with the restriction that, after homolytic cleavage of the S—R bond, R forms either a secondary, tertiary or aromatically stabilized free radical.

It is particularly preferable to use a regulator of the general formula (VIc) in which
R, with the proviso that, after homolytic cleavage of the S—R bond, R forms either a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or unsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)arylalkyl moiety, very particularly preferably a C₇-C₂₅-(hetero)arylalkyl moiety, in particular benzyl, phenylethyl or 1-methyl-1-phenyleth-2-yl, or
   is thiocarboxy, carbonyl, carboxy, oxo, thioxo, epoxy, or else a salt of the abovementioned compounds.

### Asymmetrical Trithiocarbonates:

Another preferred embodiment uses at least one regulator of the general formula (VId),

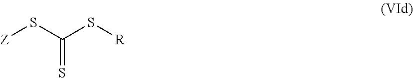

in which
Z has the meanings previously specified for the general formula (VI), but with the restriction that, after homolytic cleavage of the S—Z bond, Z forms a primary free radical, and
R can have the same meanings as Z in the general formula (VI), but with the restriction that, after homolytic cleavage of the S—R bond, R forms either a secondary, tertiary or aromatically stabilized free radical, and
   with the additional proviso that Z and R assume different meanings.

This preferred regulator of the general formula (VId) derives from the regulator of the general formula (VI) where
n and m are respectively=0,
t is equal to 1,
X is sulphur,
Z has the meanings previously specified for the general formula (VI), but with the restriction that, after homolytic cleavage of the S—Z bond, Z forms a primary free radical, and
R can have the same meanings as Z in the general formula (VI), but with the restriction that, after homolytic cleavage of the S—R bond, R forms either a secondary, tertiary or aromatically stabilized free radical.

These particularly preferred regulators of the general formula (VId) therefore involve asymmetrical trithiocarbonates.

Particular preference is given to a regulator of the abovementioned general formula (VId) in which
Z, with the proviso that, after homolytic cleavage of the S—Z bond, Z forms a primary free radical, is H, a linear or branched, saturated or mono- or polyunsaturated, optionally mono- or polysubstituted alkyl moiety, very particularly preferably a corresponding C₁-C₁₆ alkyl moiety, in particular methyl, ethyl, n-prop-1-yl, but-2-en-1-yl, n-pent-1-yl, n-hex-1-yl or n-dodecan-1-yl, or aralkyl, very particularly preferably C₇-C₂₅-aralkyl, in particular benzyl, amino, amido, carbamoyl, hydroxyimino, alkoxy, aryloxy, F, Cl, Br, I, hydroxy, alkylthio, arylthio, carbonyl, carboxy, oxo, thioxo, cyanates, thiocyanates, isocyanates, thioisocyanates, isocyanides or a salt of the compounds specified and
R, with the proviso that, after homolytic cleavage of the S—R bond, R forms either a secondary, tertiary or aromatically stabilized free radical,
   is a linear, branched or cyclic, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or unsaturated, optionally mono- or polysubstituted carbocyclyl or heterocyclyl moiety, in particular cyclohexyl, cumyl or cyclohexane-1-nitrile-1-yl,
   is an aryl moiety or heteroaryl moiety, very particularly preferably a C₆-C₂₄-aryl moiety, in particular phenyl, pyridinyl or anthracenyl,
   is an aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

### Dithioesters:

Another preferred embodiment uses at least one regulator of the general formula (VIe),

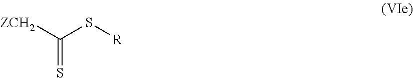

in which
Z can have any of the meanings specified for the general formula (VI) and
R can have the same meanings as Z in the general formula (VI), but with the restriction that, after homolytic cleavage of the S—R bond, R forms either a secondary, tertiary or aromatically stabilized free radical.

This preferred regulator of the general formula (VIe) derives from the regulator of the general formula (VI), where
n and m are respectively 0,
t is equal to 1,
X is CH₂,
Z has the meanings previously specified for the general formula (VI) and
R can have the same meanings as Z in the general formula (VI), but with the restriction that, after homolytic cleavage of the S—R bond, R forms either a secondary, tertiary or aromatically stabilized free radical.

Particular preference is given to a regulator of the abovementioned general formula (VIe), in which
R, with the proviso that, after homolytic cleavage of the S—R bond, R forms either a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or unsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)arylalkyl moiety, very particularly preferably a C₇-C₂₅(hetero)arylalkyl moiety, in particular benzyl, phenylethyl or 1-methyl-1-phenyleth-2-yl, or
   is thiocarboxy, carbonyl, carboxy, oxo, thioxo, epoxy, or else a salt of the abovementioned compounds.

All of the abovementioned regulators can be synthesized by methods familiar from the prior art to the person skilled in the art. Synthesis instructions and other references for production instructions can be found by way of example in Polymer 49 (2008) 1079-1131 and in any of the patents and literature references mentioned previously as prior art in this application. Many of the regulators are also already obtainable commercially.

The following are particularly suitable as regulators in embodiment (2) of the process according to the invention: dodecylpropanoic acid trithiocarbonate (DoPAT), dibenzoyl trithiocarbonate (DiBenT), cumyl phenyl dithioacetate (CPDA), cumyl dithiobenzoate, phenyl ethyl dithiobenzoate, cyanoisopropyl dithiobenzoate (CPDB), 2-cyanopropyl dodecyl trithiocarbonate, 2-cyanoethyl dithiobenzoate, 2-cyanoprop-2-yl dithiophenylacetate, 2-cyanoprop-2-yl dithiobenzoate, S-thiobenzoyl-1H,1H,2-keto-3-oxa-4H,4H,5H,5H-perfluoroundecanethiol and S-thiobenzoyl-1-phenyl-2-keto-3-oxa-4H,4H,5H,5H-perfluoroundecanethiol.

It is usual in embodiment (2) of the process according to the invention to use from 5 to 2000 mol % of the regulator, based on 1 mol of the initiator. It is preferable to use from 20 to 1000 mol % of the regulator, based on 1 mol of the initiator.

The compounds that can be used in embodiment (2) of the process according to the invention and that have the general formula (VIb) are known from “RAFT” technology, see the literature references cited above in that connection.

### Embodiment (3) of the Process According to the Invention

Embodiment (3) of the process according to the invention uses at least one compound selected from the group consisting of the abovementioned compounds (i) to (xii).

Preferred mercaptans (i) are alkyl mercaptans, particular preference being given to C₁-C₁₆ alkyl mercaptans, which may be branched or unbranched. Especially preferred are methyl mercaptan, ethyl mercaptan, n-butyl mercaptan, n-hexyl mercaptan, n-octyl mercaptan, n-dodecyl mercaptan, tert-nonyl mercaptan and tert-dodecyl mercaptans. Tertiary mercaptans can be used in the form of individual isomers and in the form of mixtures of two or more isomers.

Preferred mercapto alcohols (ii) are aliphatic or cycloaliphatic mercapto alcohols, more particularly 2-mercapto-1-ethanol, 3-mercapto-1-propanol, 3-mercaptopropane-1,2-diol (also known as thioglycerol), 4-mercapto-1-butanol and 2-mercaptocyclohexanol.

Preferred mercaptocarboxylic acids (iii) are mercaptoacetic acid (also designated sulphanylacetic acid), 3-mercaptopropionic acid, mercaptobutanedioic acid (also known as mercaptosuccinic acid), cysteine and N-acetylcysteine. Preferred mercaptocarboxylic esters (iii) are alkyl thioglycolates, more particularly ethylhexyl thioglycolate.

A preferred thiocarboxylic acid (iv) is thioacetic acid.

Preferred disulphides (v) are xanthogen disulphides, particular preference being given to diisopropylxanthogen disulphide.

Preferred allyl compounds (vii) are allyl alcohol or allyl chloride.

A preferred aldehyde (viii) is crotonaldehyde.

Preferred aliphatic or araliphatic halohydrocarbons (ix) are chloroform, carbon tetrachloride, iodoform or benzyl bromide.

The abovementioned molar-mass regulators are known in principle from the literature (see K. C. Berger and G. Brandrup in J. Brandrup, E. H. Immergut, Polymer Handbook, 3rd edn., John Wiley & Sons, New York, 1989, p. II/81-II/141) and are available commercially or alternatively may be prepared by methods from the literature which are known to the skilled person (see, for example, Chimie & Industrie, Vol. 90 (1963), No. 4, 358-368, U.S. Pat. No. 2,531,602, DD 137 307, DD 160 222, U.S. Pat. No. 3,137,735, WO-A-2005/082846, GB 823,824, GB 823,823, JP 07-316126, JP 07-316127, JP 07-316128).

A feature of molar-mass regulators is that in the context of the polymerization reaction they accelerate chain-transfer reactions and hence bring about a lowering of the degree of polymerization of the resultant polymers. The abovementioned regulators include mono-, di- and polyfunctional regulators, depending on the number of functional groups in the molecule that are able to lead to one or more chain-transfer reactions.

The molar mass regulators for use in the process of the invention are more preferably tert-dodecyl mercaptans, in the form of individual isomers and in the form of mixtures of two or more isomers.

tert-Dodecyl mercaptans are often prepared by acidically catalysed addition reaction of hydrogen sulphide with olefins having 12 carbons. As Cₒ olefin starting material (also referred to as “C₁₂ feedstock”), use is made predominantly of oligomer mixtures based on tetramerized propene (also called “tetrapropene” or “tetrapropylene”), trimerized isobutene (also called “triisobutene” or “triisobutylene”), trimerized n-butene and dimerized hexene.

As molar-mass regulators in the process of the invention it is especially preferred to use one or more tert-dodecyl mercaptans selected from the group consisting of 2,2,4,6,6-pentamethylheptane-4-thiol, 2,4,4,6,6-pentamethylheptane-2-thiol, 2,3,4,6,6-pentamethylheptane-2-thiol, 2,3,4,6,6-pentamethylheptane-3-thiol and any desired mixtures of two or more of the abovementioned isomers.

Use is made more particularly in variant (3) of the process of the invention of a mixture comprising 2,2,4,6,6-pentamethylheptane-4-thiol, 2,4,4,6,6-pentamethylheptane-2-thiol, 2,3,4,6,6-pentamethylheptane-2-thiol and 2,3,4,6,6-pentamethylheptane-3-thiol. The preparation of this mixture is described in EP-A-2 162 430.

It is usual in variant (3) of the process according to the invention to use from 1 to 5000 mol % of the molar-mass regulator (i) to (ix), based on 1 mol of initiator. It is preferable to use from 5 to 2000 mol % of the molar-mass regulator, based on 1 mol of the initiator.

### Initiators:

The process according to the invention involves free-radical polymerization. The manner in which this is initiated is not critical, insofar as it is possible to use initiation by one or more initiators selected from the group consisting of peroxidic initiators, azo initiators and redox systems, or photochemical initiation. Among the said initiators, preference is given to the azo initiators.

The following compounds can be used by way of example as azo initiators: 2,2′-azobis(isobutyronitrile), 2,2′-azobis(2-cyano-2-butane), dimethyl 2,2′-azobisdimethyliso-butyrate, 4,4′-azobis(4-cyanopentanoic acid), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]propionamide, 2,2′-azobis(N,N-dimethylene(sobutyramidine) dihydrochloride, 2,2′-azobis(2-amidinopropane) dihydrochloride, 2,2′-azobis(N,N′-dimethyleneisobutyramine), 2,2′-azobis(2-methy)-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)-propionamide], 2,2′-azobis(isobutyramide) dihydrate, 2,2′-azobis(2,2,4-trimethylpentane), 2,2′-azobis(2-methylpropane), 1,1′-azobis(cyclohexane-1-carbonitrile), 2,2′-azobis[N-(2-propenyl)-2-methylpropionamide], 1-[(1-cyano-1-methylethyl)azo]formamide, 2,2′-azobis(N-butyl-2-methylpropionamide), 2,2′-azobis(N-cyclohexyl-2-methylpropionamide) and 2,2′-azobis(2,4,4-trimethylpentane).

The azo initiators are used typically in an amount of 10⁻⁴ to 10⁻¹ mol/l, preferably in an amount of 10⁻³ to 10⁻² mol/l. By harmonizing the proportion of the amount of initiator used to the amount of the regulator used, success is achieved in specifically influencing not only the reaction kinetics but also the molecular structure (molar mass, polydispersity).

Peroxidic initiators that can be used include, for example, the following peroxo compounds, containing an —O—O unit: hydrogen peroxide, peroxodisulphates, peroxodiphosphates, hydroperoxides, peracids, peracid esters, peracid anhydrides and peroxides having two organic moieties. As salts of peroxodisulphuric acid and of peroxodiphosphoric acid it is possible to use sodium, potassium and ammonium salts. Examples of suitable hydroperoxides include t-butyl hydroperoxide, cumene hydroperoxide, pinane hydroperoxide and p-menthane hydroperoxide. Suitable peroxides having two organic moieties are dibenzoyl peroxide, 2,4-dichlorobenzoyl peroxide, 2,5-dimethylhexane-2,5-di-t-butyl peroxide, bis(t-buty)peroxyisopropyl)benzene, t-butyl cumyl peroxide, di-t-butyl peroxide, dicumyl peroxide, t-butyl perbenzoate, t-butyl peracetate, 2,5-dimethylhexane 2,5-diperbenzoate, t-butyl per-3,5,5-trimethylhexanoate. Preference is given to using p-menthane hydroperoxide, cumene hydroperoxide or pinane hydroperoxide.

In an alternative embodiment, azo initiators or peroxidic initiators with a prolonged decomposition time are used. In this case it has been found appropriate to select the azo initiator or peroxidic initiator such that the half-life of the respective initiator in the selected solvent is 10 hours or more than 10 hours at a temperature of 70° C. to 200° C., preferably 80° C. to 175° C., more preferably 85° C. to 160° C. and more particularly 90° C. to 150° C. Preference is given here to azo initiators which possess a half-life of 10 hours or more than 10 hours in the selected solvent at a temperature of 70° C. to 200° C., preferably 80° C. to 175° C., more preferably 85° C. to 160° C. and very particularly preferably 90° C. to 150° C. It is particularly preferred to use azo initiators of the following structural formulae (Ini-1) (Ini-6):

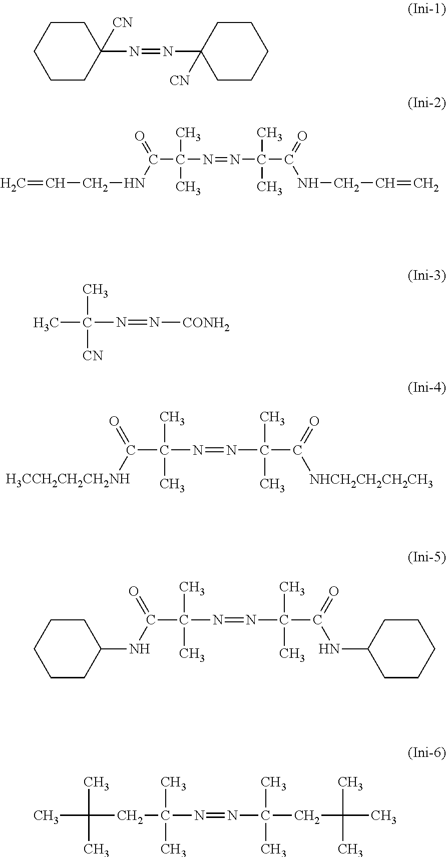

Especially preferred is the use of the initiators of the formulae (Ini-2) and (Ini-3).

The above azo initiators of the structural formulae (Ini-1) (Ini-6) are available commercially, for example from Wako Pure Chemical Industries, Ltd.

The concept of the half-life is familiar to the skilled person in connection with initiators. Merely as an example: a half-life of 10 hours in a solvent at a particular temperature means specifically that, under these conditions, half of the initiator has undergone decomposition after 10 hours.

When the above preferred initiators with a relatively high decomposition temperature are used, especially the stated azo initiators, it is possible to synthesize nitrile rubbers having comparatively higher average molar masses Mw (weight average of the molar mass) and Mn (number average of the molar mass) which are also notable at the same time for a high linearity. This is manifested by correspondingly low values for the Mooney relaxation, measured by ISO 289 parts 1 & 2 or alternatively in accordance with ASTM D1646.

Redox systems which can be used are the following systems composed of an oxidizing agent and a reducing agent. The choice of suitable amounts of oxidizing agent and reducing agent is sufficiently familiar to the skilled person.

In the case where redox systems are used, it is common to make additional use of salts of transition metal compounds such as iron, cobalt or nickel in combination with suitable complexing agents such as sodium ethylenediaminetetraacetate, sodium nitrilotriacetate and also trisodium phosphate or tetrapotassium diphosphate.

Oxidizing agents which can be used in this context include, for example, all peroxo compounds identified above for the peroxidic initiators.

Reducing agents which can be used in the process of the invention include, for example, the following: sodium formaldehydesulphoxylate, sodium benzaldehydesulphoxylate, reducing sugars, ascorbic acid, sulphenates, sulphinates, sulphoxylates, dithionite, sulphite, metabisulphite, disulphite, sugars, urea, thiourea, xanthogenates, thioxanthogenates, hydrazinium salts, amines and amine derivatives such as aniline, dimethylaniline, monoethanolamine, diethanolatnine or triethanolamine. Preference is given to using sodium formaldehydesulphoxylate.

The free-radical polymerization may also be initiated photochemically as described below: for this purpose a photoinitiator is added to the reaction mixture, the photoinitiator being excited by exposure to light of appropriate wavelength, and initiating a free-radical polymerization. Here it should be noted that for the optimum initiation of the free-radical polymerization, the irradiation time is dependent on the power of the radiation source, on the distance between the radiation source and the reaction vessel, and on the area of irradiation. To the skilled person, however, it is readily possible, by means of various test series, to determine the optimum irradiation time. The choice of the suitable amount of initiator is also possible without problems to a skilled person, and is used to influence the time/conversion behaviour of the polymerization.

Examples of photochemical initiators which can be used include the following: benzophenone, 2-methylbenzophenone, 3,4-dimethylbenzophenone, 3-methyl benzophenone, 4,4′-bis(diethylamino)benzophenone, 4,4′-dihydroxybenzophenone, 4,4′-bis[2-(1-propenyl)-phenoxy]benzophenone, 4-(diethylamino)benzophenone, 4-(dimethylamino)benzophenone, 4-benzoylbiphenyl, 4-hydroxybenzophenone, 4-methylbenzophenone, benzophenone-3,3′,4,4′-tetracarboxylic dianhydride, 4,4′-bis(dimethylamino)benzophenone, acetophenone, 1-hydroxycyclohexyl phenyl ketone, 2,2-diethoxyacetophenone, 2,2-dimethoxy-2-phenylacetophenone, 2-benzyl-2-(dimethylamino)-4-morpholinobutyrophenone, 2-hydroxy-2-methylpropiophenone, 2-hydroxy-4′-(2-hydroxyethoxy)-2-methylpropiophenone, 3′-hydroxyacetophenone, 4″-ethoxyacetophenone, 4′-hydroxyacetophenone, 4′-phenoxyacetophenone, 4″-tert-butyl-2′,6′-dimethylacetophenone, 2-methyl-4′-(methylthio)-2-morpholinopropiophenone, diphenyl(2,4,6-trimethylbenzoyl)phosphine oxide, phenylbis(2,4,6-trimethylbenzoyl)phosphine oxide, methyl benzoylformate, benzoin, 4,4′-dimethoxybenzoin, benzoin methyl ether, benzoin ethyl ether, benzoin isopropyl ether, benzoin isobutyl ether, 4,4′-dimethylbenzil, hexachlorocyclopentadienes or a combination thereof.

### Solvents:

The process according to the invention is carried out in a mixture of at least two solvents, where the amount used of the first solvent is in the range from 70 to 99.9% by volume, based on the entirety of all of the solvents used. This first solvent is also hereinafter termed “main solvent”. The total amount used of the second (and optionally one or more other) solvent(s) (also hereinafter termed “additional solvents” in their entirety) is accordingly in the range from 0.01 to 30% by volume, based on the entirety of all of the solvents used.

It is preferable that the amount used of the main solvent is in the range from 75 to 99.9% by volume, particularly from 85 to 99.5% by volume, based on the entirety of all of the solvents used, and that the total amount used of the additional solvent(s) is from 0.1 to 25% by volume, particularly from 0.5 to 15% by volume, again based on the entirety of all of the solvents used.

Examples of suitable main solvents are dimethylacetamide, monochlorobenzene, toluene, ethyl acetate, 1,4-dioxane, acetonitrile, tert-butanol, tert-butyl nitrile, dimethyl carbonate, methyl acetate, isobutyronitrile and acetone.

Preference is given to main solvents which have a Hildebrand solubility parameter δ (δ=((ΔH_{V}−RT)/Vₘ)^{1/2}[(MPa)^{1/2}] (Vₘ=molar volume; ΔH_{V}=enthalpy of vaporization; R=ideal gas constant)) in the range from 15.5 to 26 (MPa)^{1/2}. It is preferable to use solvents of which the solubility parameter is from 16 to 25 (MPa)^{1/2}.

Examples of suitable additional solvents are any of the abovementioned solvents, insofar as the main solvent involves a solvent other than the additional solvent. Other suitable additional solvents are: water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol and methanol.

One embodiment of the process according to the invention uses, as main solvent, a solvent selected from the group consisting of dimethylacetamide, monochlorobenzene, toluene, ethyl acetate, 1,4-dioxane, acetonitrile, tert-butanol, tert-butyl nitrile, dimethyl carbonate, methyl acetate, isobutyronitrile and acetone, and uses one or more other solvents different from the main solvent and selected from the group consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol and methanol.

It is essential that in the process according to the invention the reaction system does not comprise large amounts of water, as in the case of emulsion polymerization. Relatively small amounts of water of the order of magnitude of up to 5% by weight, preferably up to 1% by weight (based on the amount of the organic solvent) can certainly be present in the reaction system. If water is also used as additional solvent, it is important that the total amount of water present must be such that there is no precipitation of the NBR polymer which forms. However, a person skilled in the art can easily determine this by experimental trials. It should be clearly stated at this point that the process according to the invention does not involve emulsion polymerization.

For the suitability of a solvent, it is decisive that the nitrile rubber produced remains entirely in solution at the reaction temperature, which is usually in the range stated below. It is not possible to use solvents which intervene in the reaction as transfer reagents, for example carbon tetrachloride, thiols and other solvents of this type known per se to the person skilled in the art.

It is preferable to use monochlorobenzene as main solvent in combination with one or more, preferably one, other solvent(s) selected from the group consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol, methanol, isobutyronitrile, dimethyl carbonate, trimethylacetonitrile, and methyl acetate. Particular preference is given to the combination of monochlorobenzene as main solvent and N,N-dimethylacetamide as additional solvent.

Other preferred combinations of a main solvent with one or more, preferably one, other solvent(s) are: tert-butanol, 1,4-dioxane, acetonitrile, toluene, isobutyronitrile, isopropyl methyl ketone, N,N-dimethylacetamide, dimethyl carbonate, trimethylacetonitrile, and methyl acetate as main solvent, with another solvent selected from the group, differing from the main solvent and consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol. N,N-dimethylformamide, ethanol, 1,3-butanediol, diethylene glycol, methanol, isobutyronitrile, dimethyl carbonate, trimethylacetonitrile, and methyl acetate.

### Temperature:

The process according to the invention is usually carried out at a temperature in the range from 5° C. to 150° C., preferably in the range from KC to 130° C., particularly preferably in the range from 9° C. to 120° C. and in particular in the range from 10′C to 110° C. If the selected temperature is still lower, the polymerization process is correspondingly slower. If temperatures are markedly higher, it is possible that the initiator used decomposes too rapidly or that the RAFT agent is decomposed. In particular when peroxidic initiators are used, oxidation of the regulator can sometimes occur.

### Reaction:

In the case of initiation by peroxo compounds or azo initiators, the conduct of the process according to the invention is usually such that the α,β-unsaturated nitrile and the optionally used other copolymerizable monomers, the solvent, the initiator and the regulator(s) form an initial charge in a reaction vessel, and then the conjugated diene(s) is/are metered into the mixture. The polymerization process is then initiated through temperature increase.

In the case of initiation by means of a redox system, the oxidizing agent is typically metered into the reaction vessel together with one of the monomers. The polymerization process is then initiated through addition of the reducing agent.

A useful method which is certainly familiar to the person skilled in the art for obtaining specific ratios of the respective monomers in the co/terpolymer is to undertake appropriate metering modifications (e.g. by metering further amounts of the respective monomer, of initiator, of regulator or of solvent into the mixture). These further amounts can be metered into the mixture either continuously or else batchwise in individual portions. The metering of further amounts of monomers or else of further amounts of initiator into the mixture can also take place either continuously or else in individual portions batchwise.

A method which has proved successful for adjusting to a suitable molar mass, and also for purposes of achieving the desired conversion, in one embodiment of the process according to the invention, meters further amounts not only of the initiator but also of solvent on one or more occasions during the course of the polymerization reaction.

### Nitrile Rubbers:

In embodiment (2) of the process of the invention, the resultant nitrile rubbers (like the hydrogenated nitrile rubbers deriving therefrom through hydrogenation) feature the presence of one or more structural elements of the general formulae (I), (II), (III), (IV) or (V) either in the main polymer chain or as terminal groups. Optionally hydrogenated nitrile rubbers of this type can, by virtue of the said structural elements/terminal groups, be subjected to downstream reactions with other polymerizable monomers, since the structural elements/terminal groups can function as RAFT agents by way of further fragmentation. This method permits the targeted construction of a very wide variety of polymer architectures. Furthermore, the said optionally hydrogenated nitrile rubbers according to the invention can also be crosslinked more easily than conventional nitrile rubbers, since the structural elements/terminal groups are structurally similar to the conventional crosslinking agents, in particular to those based on sulphur. To this extent, it is possible to achieve an adequate crosslinking density with the optionally hydrogenated nitrile rubbers according to the invention even with a relatively small amount of crosslinking agent. Furthermore, crosslinking by way of the terminal groups reduces the number of loose polymer-chain ends in the vulcanisate, thus giving improved properties, e.g. dynamic properties.

These optionally hydrogenated nitrile rubbers comprise
(i) repeat units derived from at least one conjugated diene, from at least one α,β-unsaturated nitrile and optionally from one or more other copolymerizable monomers and
(ii) one or more structural elements of the general formulae (I), (II), (III), (IV) or (V)

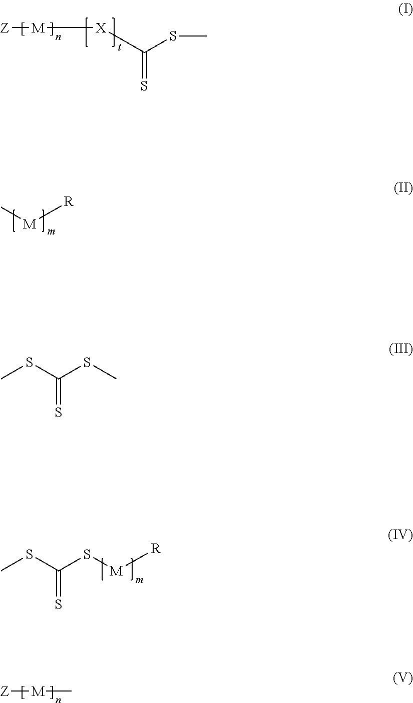

where
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0.
X is C(Z₂), N(Z), P(Z), P(═O)(Z), O, S, S(═O) or S(═O)₂, where Z in these moieties can have the same meanings as stated previously and
R (a) if m≠0, can have the same meanings as the moiety Z and
   (b) if m=0, is H, a linear or branched, saturated, or mono- or polyunsaturated alkyl moiety, a saturated, or mono- or polyunsaturated carbo- or heterocyclyl moiety, aryl, heteroalyl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides.

The meanings specified for the abovementioned moieties Z and R can respectively have mono- or polysubstitution. The information already provided in relation to Z and R for the general formula (VI) applies identically here. The information provided for the general formula (VI) in relation to the inclusion of certain meanings for Z and R (in the form of salts of the specified moieties, of organometallic salts, in the form of ligands for organometallic complex compounds, and the coupling by way of linkers to solid phases or to support substances) also applies in identical fashion to Z and R in the general structural elements (I)-(V). The information provided in relation to the optional substitution of the meanings behind M relating to the general formula (VI) also applies in identical fashion to the general structural element (I), (II), (IV) and (V).

By way of embodiment (2) of the process according to the invention it is preferably possible to obtain optionally hydrogenated nitrile rubbers which comprise structural elements (ii) of the general formulae (VIb-1) and (VIb-2)

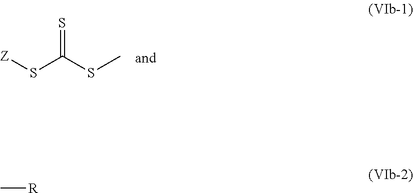

in which
Z has the meanings previously specified for the general formula (I) and
R has the meanings previously specified for the general formula (I), but with the restriction that, after homolytic cleavage of the bond to the next-bonded atom in the nitrile rubber, R forms either a secondary, tertiary or aromatically stabilized free radical.

It has proved particularly successful for Z and R here to be different.

The said structural elements are present as terminal groups in the nitrile rubbers and are obtained on use of the preferred regulators of the general formula (VIb).

One preferred embodiment of the process according to the invention, in variant (2), gives nitrile rubbers which comprise, as general structural elements (ii), the terminal group n(VIb-1) and (VIb-2), in which R, with the proviso that, after homolytic cleavage of the bond to the next-bonded atom, R forms either a secondary, tertiary or aromatically stabilized free radical,
is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
is a saturated or mono- or polyunsaturated, optionally mono- or polysubstituted carbocyclyl or heterocyclyl moiety, in particular cyclohexyl, cumyl or cyclohexane-1-nitrile-1-yl,
is a (hetero)aryl moiety, very particularly preferably a C₆-C₂₄-(hetero)aryl moiety, in particular phenyl, pyridinyl or anthracenyl,
is a (hetero)aralkyl moiety, very particularly preferably benzyl, phenylethyl or 1-methyl-1-phenyleth-2-yl, or
is thiocarboxy, carbonyl, carboxy, oxo, thioxo, epoxy, or else a salt of the abovementioned compounds.

One particularly preferred embodiment of the process according to the invention, in variant (2), gives optionally hydrogenated nitrite rubbers which comprise, as general structural elements (ii),

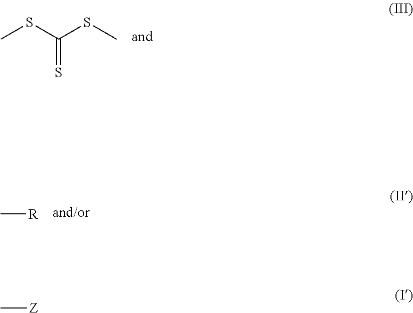

where
Z can have the same meanings as in the general formula (I) and
R can have the same meanings as in the general formula (II) for m=0, and
R and Z are identical or different, but always with the proviso that, after homolytic cleavage of their bond to the respective next atom in the optionally hydrogenated nitrile rubber, R and Z respectively form a secondary, tertiary or aromatically stabilized free radical.

Optionally hydrogenated nitrile rubbers having the abovementioned general structural elements (ii) are obtained when a compound of the general structural formula (VIb) is used as regulator, in which Z has the same meanings as in the general formula (VI) and R has the same meanings as in the general formula (VI) for the variant b) where m=0, and R and Z are identical or different, but always with the proviso that, after homolytic cleavage of their bond to the respective closest sulphur in the regulator, R and Z respectively form a secondary, tertiary or aromatically stabilized free radical.

Another particularly preferred embodiment of the process according to the invention, in variant (2), gives optionally hydrogenated nitrile rubbers which comprise, as general structural elements (ii), the elements (III) and (II′) and/or (I′), in which
R and Z are identical or different, and with the proviso that, after homolytic cleavage of the bond to the respective next-bonded atom. R and Z respectively form a secondary, tertiary or aromatically stabilized free radical,
   are a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   are a saturated or mono- or polyunsaturated, optionally mono- or polysubstituted carbocyclyl or heterocyclyl moiety, in particular cyclohexyl, cumyl or cyclohexane-1-nitrile-1-yl,
   are a (hetero)aryl moiety, very particularly preferably a C₆-C₂₄-(hetero)aryl moiety, in particular phenyl, pyridinyl or anthracenyl,
   are a (hetero)aralkyl moiety, very particularly preferably benzyl, phenylethyl or 1-methyl-1-phenyleth-2-yl, or
   are thiocarboxy, carbonyl, carboxy, oxo, thioxo, epoxy, or else a salt of the abovementioned compounds.

Another particularly preferred embodiment of the process according to the invention, in variant (2), gives optionally hydrogenated nitrile rubbers which comprise, as general structural elements (ii),

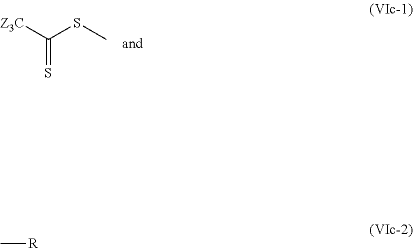

in which
Z has the meanings previously specified for the general formula (I),
R has the meanings previously specified for the general formula (II), but with the restriction that, after homolytic cleavage of the bond to the next atom in the optionally hydrogenated nitrile rubber, R forms a secondary, tertiary or aromatically stabilized free radical.

The said structural elements are present as terminal groups in the optionally hydrogenated nitrile rubbers and are obtained on use of the preferred regulators of the general formula (VIc).

Another particularly preferred embodiment of the process according to the invention, in variant (2), gives optionally hydrogenated nitrile rubbers which comprise, as general structural elements (ii), the structural elements (VIc-1) and (VIc-2), in which
R, with the proviso that, after homolytic cleavage of the bond to the next atom in the optionally hydrogenated nitrile rubber, R forms a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or mono- or polyunsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

In all three embodiments (1)-(3) of the process according to the invention, a feature of the resultant nitrile rubbers, and also of the hydrogenated nitrile rubbers optionally obtained therefrom through hydrogenation, is that, unlike corresponding rubbers which are obtained by way of emulsion polymerization according to the prior art, they are completely emulsifier-free and also contain none of the salts that are usually used for coagulation of the latices after emulsion polymerization, for purposes of precipitation of the nitrile rubber.

By way of the process according to the invention it is possible in all three variants to co- or terpolymerize the following monomers:

The conjugated diene in the nitrile rubber can be of any type. It is preferable to use (C₄-C₆) conjugated dienes. Particular preference is given to 1,2-butadiene, 1,3-butadiene, isoprene, 2,3-dimethylbutadiene, piperylene, and mixtures thereof. In particular, 1,3-butadiene and isoprene and mixtures thereof are preferred. 1,3-Butadiene is very particularly preferred.

α,β-Unsaturated nitrile used can comprise any known α,β-unsaturated nitrile, preference being given to (C₃-C₅)-α,β-unsaturated nitriles such as acrylonitrile, methacrylonitrile, ethacrylonitrile and mixtures thereof. Acrylonitrile is particularly preferred.

One particularly preferred nitrile rubber is a copolymer of acrylonitrile and 1,3-butadiene.

Other copolymerizable termonomers that can be used comprise by way of example aromatic vinyl monomers, preferably styrene, α-methylstyrene and vinylpyridine, fluorinated vinyl monomers, preferably fluorinated ethyl vinyl ether, fluorinated propyl vinyl ether, o-fluoromethylstyrene, vinyl pentafluorobenzoate, difluoroethylene and tetrafluoroethylene, or else copolymerizable anti-ageing monomers, preferably N-(4-anilinophenyl)acrylamide. N-(4-anilinophenyl)-methacrylamide, N-(4-anilinophenyl)cinnamides, N-(4-anilinophenyl)crotonamide, N-phenyl-4-(3-vinylbenzyloxy)aniline and N-phenyl-4-(4-vinylbenzyloxy)aniline, and also non-conjugated dienes, such as 4-cyanocyclohexene and 4-vinylcyclohexene, or else alkynes, such as 1- or 2-butyne.

As an alternative, other copolymerizable termonomers that can be used comprise carboxylated, copolymerizable termonomers, for example α,β-unsaturated monocarboxylic acids, their esters, α,β-unsaturated dicarboxylic acids, their mono- or diesters or their corresponding anhydrides or amides.

α,β-Unsaturated monocarboxylic acids that can be used preferably comprise acrylic acid and methacrylic acid.

It is also possible to use esters of the α,β-unsaturated monocarboxylic acids, preferably their alkyl esters and alkoxyalkyl esters. Preference is given to the alkyl esters, in particular C₁-C₁₈ alkyl esters, of the α,β-unsaturated monocarboxylic acids. Particular preference is given to alkyl esters, in particular C₁-C₁₈ alkyl esters, of acrylic acid or of methacrylic acid, in particular methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particularly alkoxyalkyl esters of acrylic acid or of methacrylic acid, in particular C₂-C₁₂-alkoxyalkyl esters of acrylic acid or of methacrylic acid, very particularly methoxymethyl acrylate, methoxyethyl (meth)acrylate, ethoxyethyl (meth)acrylate and methoxymethyl (meth)acrylate. It is also possible to use mixtures of alkyl esters, e.g. of those mentioned above, with alkoxyalkyl esters, e.g. in the form of those mentioned above. It is also possible to use cyanoalkyl acrylates and cyanoalkyl methacrylates, where the number of carbon atoms in the cyanoalkyl group in these is from 2 to 12, preferably α-cyanoethyl acrylate, β-cyanoethyl acrylate and cyanobutyl methacrylate. It is also possible to use hydroxyalkyl acrylates and hydroxyalkyl methacrylates, where the number of carbon atoms in the hydroxyalkyl groups in these is from 1 to 12, preferably 2-hydroxyethyl acrylate, 2-hydroxyethyl methacrylate and 3-hydroxypropyl acrylate. It is also possible to use fluorinated benzylated acrylates or methacrylates, preferably fluorobenzyl acrylates, and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, for example dimethylaminomethyl acrylate and diethylaminoethyl acrylate.

Other copolymerizable monomers that can be used also comprise α,β-unsaturated dicarboxylic acids, preferably maleic acid, fumaric acid, crotonic acid, itaconic acid, citraconic acid and mesaconic acid.

It is also possible to use α,β-unsaturated dicarboxylic anhydrides, preferably maleic anhydride, itaconic anhydride, citraconic anhydride and mesaconic anhydride.

It is also possible to use mono- or diesters of α,β-unsaturated dicarboxylic acids.

The said α,β-unsaturated dicarboxylic mono- or diesters can by way of example involve alkyl, preferably C₁-C₁₀-alkyl, in particular ethyl, n-propyl, isopropyl, n-butyl, tert-butyl, n-pentyl or n-hexyl, alkoxyalkyl, preferably C₂-C₁₂-alkoxyalkyl, particularly preferably C₃-C₈-alkoxyalkyl, hydroxyalkyl, preferably C₁-C₁₂-hydroxyalkyl, particularly preferably C₂-C₈-hydroxyalkyl, epoxyalkyl, preferably C₃-C₁₂-epoxyalkyl, cycloalkyl, preferably C₅-C₁₂-cycloalkyl, particularly preferably C₆-C₁₂-cycloalkyl, alkylcycloalkyl, preferably C₆-C₁₂-alkylcycloalkyl, particularly preferably C₇-C₁₀-alkylcycloalkyl, aryl, preferably C₆-C₁₄-aryl, mono- or diesters, where the diesters can respectively also involve mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propyl-heptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxymethyl (meth)acrylate. More particularly, methoxyethyl acrylate is used.

Particularly preferred hydroxyalkyl esters of the α,β-unsaturated monocarboxylic acids are hydroxyethyl (meth)acrylate, hydroxypropyl (meth)acrylate and hydroxybutyl (meth)acrylate.

Particularly preferred epoxyalkyl esters of the α,β-unsaturated monocarboxylic acids are 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl acrylate, glycidylmethyl methacrylate, glycidyl acrylate, 3′,4′-epoxyheptyl 2-ethylacrylate, 3′,4′-epoxyheptyl 2-ethylmethacrylate, 6′,7′-epoxyheptyl acrylate, 6′,7′-epoxyheptyl methacrylate.

Other esters of α,β-unsaturated monocarboxylic acids also used comprise by way of example polyethylene glycol (meth)acrylate, polypropylene glycol (meth)acrylate, N-(2-hydroxyethyl)-acrylamide, N-(2-hydroxymethyl)acrylamide and urethane (meth)acrylate.

Examples of α,β-unsaturated dicarboxylic monoesters comprise
maleic acid monoalkyl esters, preferably monomethyl maleate, monoethyl maleate, monopropyl maleate and mono-n-butyl maleate;
maleic acid monocycloalkyl esters, preferably monocyclopentyl maleate, monocyclohexyl maleate and monocycloheptyl maleate;
maleic acid monoalkyl cycloalkyl esters, preferably monomethyl cyclopentyl maleate and monoethyl cyclohexyl maleate;
maleic acid monoaryl esters, preferably monophenyl maleate;
maleic acid monobenzyl esters, preferably monobenzyl maleate;
fumaric acid monoalkyl esters, preferably monomethyl fumarate, monoethyl fumarate, monopropyl fumarate and mono-n-butyl fumarate;
fumaric acid monocycloalkyl esters, preferably monocyclopentyl fumarate, monocyclohexyl fumarate and monocycloheptyl fumarate;
fumaric acid monoalkyl cycloalkyl esters, preferably monomethyl cyclopentyl fumarate and monoethyl cyclohexyl fumarate;
fumaric acid monoaryl esters, preferably monophenyl fumarate;
fumaric acid monobenzyl esters, preferably monobenzyl fumarate;
citraconic acid monoalkyl esters, preferably monomethyl citraconate, monoethyl citraconate, monopropyl citraconate and mono-n-butyl citraconate;
citraconic acid monocycloalkyl esters, preferably monocyclopentyl citraconate, monocyclohexyl citraconate and monocycloheptyl citraconate;
citraconic acid monoalkyl cycloalkyl esters, preferably monomethyl cyclopentyl citraconate and monoethyl cyclohexyl citraconate;
citraconic acid monoaryl esters, preferably monophenyl citraconate;
itaconic acid monoalkyl esters, preferably monomethyl itaconate, monoethyl itaconate, monopropyl itaconate and mono-n-butyl itaconate;
itaconic acid monocycloalkyl esters, preferably monocyclopentyl itaconate, monocyclohexyl itaconate and monocycloheptyl itaconate;
itaconic acid monoalkyl cycloalkyl esters, preferably monomethyl cyclopentyl itaconate and monoethyl cyclohexyl itaconate;
itaconic acid monoaryl esters, preferably monophenyl itaconate;
itaconic acid monobenzyl esters, preferably monobenzyl itaconate.
mesaconic acid monoalkyl esters, preferably mesaconic acid monoethyl esters.

α,β-Unsaturated dicarboxylic diesters that can be used comprise the analogous diesters based on the monoester groups previously specified, where the ester groups can also involve chemically different groups.

It is moreover possible that other copolymerizable monomers used comprise compounds that can be polymerized by a free-radical route and which, per molecule, comprise two or more olefinic double bonds. Examples of these di- or polyunsaturated compounds are di- or polyunsaturated acrylates, methacrylates or itaconates of polyols, for example 1,6-hexanediol diacrylate (HDODA), 1,6-hexanediol dimethacrylate, ethylene glycol diacrylate, ethylene glycol dimethacrylate (EGDMA), diethylene glycol dimethacrylate, triethylene glycol diacrylate, butane-1,4-diol diacrylate, propane-1,2-diol diacrylate, butane-1,3-diol dimethacrylate, neopentyl glycol diacrylate, trimethylolpropane diacrylate, trimethylolpropane dimethacrylate, trimethylolethane diacrylate, trimethylolethane dimethacrylate, trimethylolpropane triacrylate, trimethylolpropane trimethacrylate (TMPTMA), glyceryl diacrylate and triacrylate, pentaerythritol di-, tri- and tetraacrylate or -methacrylate, dipentaerythritol tetra-, penta- and hexaacrylate or -methacrylate or itaconate, sorbitol tetraacrylate, sorbitol hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes having terminal hydroxy groups. Polyunsaturated monomers used can also comprise acrylamides, e.g. methylenebisacrylaraide, hexamethylene-1,6-bisacrylamide, diethylenetriaminetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate and triallyl phosphate.

When termonomers of this type are used, it is advantageously possible to conduct the polymerization to high conversions and thereby produce nitrile rubbers which have relatively high average molar mass Mw (weight average) or Mn (number average), but are nevertheless gel-free.

The content of conjugated diene and of α,β-unsaturated nitrile in the resultant NBR polymers can vary widely. The content of the conjugated diene or of the entirety of the conjugated dienes is usually in the range from 40 to 90% by weight, preferably in the range from 50 to 85% by weight, based on the entire polymer. The content of the α,β-unsaturated nitrile or of the entirety of the α,β-unsaturated nitriles is usually from 10 to 60% by weight, preferably from 15 to 50% by weight, based on the entire polymer. The total content of the monomers is always 100% by weight. The amounts present of the additional monomers can be from 0 to 40% by weight, based on the entire polymer, depending on the nature of the termonomer(s). In this case, the content of the additional monomers replaces corresponding content of the conjugated diene(s) and/or of the α,β-unsaturated nitrile(s), where the total content of all of the monomers is always 100% by weight.

To the extent that the termonomers involve monomers which form tertiary free radicals (e.g. methacrylic acid), it has proved successful to use amounts of from 0 to 10% by weight of these.

It should be noted that the restriction previously specified of at most 40% for the additional monomers applies only in the scenario where the total amount of monomers is metered into the polymerization mixture at the start of or during the reaction (i.e. to produce random terpolymer systems). In embodiment (2) it is of course possible to use an optionally hydrogenated nitrile rubber produced according to the invention as macro-regulator, through reaction with any desired amount of suitable monomers, e.g. to generate block systems, by virtue of the fact that its main polymer chain and/or its terminal groups comprise fragments of the regulator(s) used.

The glass transition temperatures of the optionally hydrogenated nitrile rubbers are in the range from −70° C. to +20° C., preferably in the range from −60′C to 10° C.

The process according to the invention can produce nitrile rubbers with polydispersity index in the range from 1.1 to 6.0, preferably in the range from 1.3 to 5.0, particularly preferably in the range from 1.4 to 4.5. In the case of embodiment (2) it is possible, by virtue of the living character of the polymerization process, to obtain nitrile rubbers with narrow molar mass distribution. It is then possible to produce nitrile rubbers with polydispersity index in the range from 1.1 to 2.5, preferably in the range from 1.3 to 2.4, particularly preferably in the range from 1.4 to 2.2, in particular in the range from 1.5 to 2.0, very particularly preferably in the range from 1.5 to less than 2.

In particular in the case of embodiment (2), the process according to the invention permits, through control of regulator concentration, very precise adjustment to the desired molar mass and moreover, through use of the regulators, also permits the construction of targeted polymer architectures (e.g. production of blocks, grafts onto polymer backbones, surface coupling, use of termonomers having more than one C═C double bond, and other polymer modifications known to the person skilled in the art), and also targeted molar mass distributions from extremely narrow through to broad distributions, and from mono- through bi- to multimodal distributions. The polydispersity index PDT of the nitrile rubbers constructed in targeted fashion by way of the said methods can be in the range from 1.1 to 8.0, preferably in the range from 1.15 to 7.0, particularly preferably in the range from 1.2 to 6.0 and in particular in the range from 1.3 to 5.0, where PDT=Mw/Mn, and where Mw is the weight average and Mn is the number average of the molar mass.

### Hydrogenation:

The free-radical polymerization process of the process according to the invention is optionally followed by hydrogenation of the nitrile rubber to give fully or partially hydrogenated nitrite rubber.

The present invention further provides hydrogenated nitrile rubbers, in that hydrogenation b) follows the first polymerization step a) immediately, without any need for the prior isolation of the nitrile rubber that occurs in the NBR emulsion polymerization process used hitherto in the prior art. The hydrogenation process can be carried out immediately after the polymerization process, and indeed in the same reactor if desired. This leads to a substantial simplification and therefore to economic advantages in producing the HNBR.

The hydrogenation can be carried out with homogeneous or heterogeneous hydrogenation catalysts. The catalysts used are usually based on rhodium, ruthenium, or titanium, but it is also possible to use platinum, iridium, palladium, rhenium, ruthenium, osmium, cobalt or copper, either in the form of metal or else preferably in the form of metal compounds (see, for example, U.S. Pat. No. 3,700,637, DE-A-25 39 132, EP-A-0 134 023, DE-A-35 41 689, DE-A-35 40 918, EP-A-0 298 386, DE-A-35 29 252, DE-A-34 33 392, U.S. Pat. No. 4,464,515 and U.S. Pat. No. 4,503,196).

Suitable catalysts and solvents for homogeneous-phase hydrogenation are described hereinafter, and are also known from DE-A-25 39 132 and EP-A-0 471 250.

Selective hydrogenation can by way of example be achieved in the presence of a rhodium- or ruthenium-containing catalyst. Use may be made, for example, of a catalyst of the general formula

(R¹ₘB)ₗMXₙ,

in which M is ruthenium or rhodium, R¹ is alike or different at each occurrence and is a C₁-C₈ alkyl group, a C₄-C₈ cycloalkyl group, a C₆-C₁₅ aryl group or a C₇-C₁₅ aralkyl group. B is phosphorus, arsenic, sulphur or a sulphoxide group S═O, X is hydrogen or an anion, preferably halogen and more preferably chlorine or bromine, l is 2, 3 or 4, m is 2 or 3 and n is 1, 2 or 3, preferably 1 or 3. Preferred catalysts are tris(triphenylphosphine)rhodium(I) chloride, tris(triphenylphosphine)rhodium(III) chloride and tris(dimethyl sulphoxide)rhodium(III) chloride and also tetrakis(triphenylphosphine)rhodium hydride of the formula (C₆H₅)₃P)₄RhH and the corresponding compounds in which some or all of the triphenylphosphine has been replaced by tricyclohexylphosphine. The catalyst can be used in small amounts. An amount in the range of 0.01-1% by weight, preferably in the range of 0.03-0.5% by weight and more preferably in the range of 0.1-0.3% by weight, based on the weight of the polymer, is suitable.

Typically it is sensible to use the catalyst together with a cocatalyst which is a ligand of the formula R¹ₘB, where R¹, m and B possess the definitions stated above for the catalyst, Preferably m is 3, B is phosphorus, and the moieties R¹ may be alike or different. The cocatalysts in question preferably have trialkyl, tricycloalkyl, triaryl, triaralkyl, diaryl-monoalkyl, diaryl-monocycloalkyl, dialkyl-monoaryl, dialkyl-monocycloalkyl, dicycloalkyl-monoaryl or dicycloalkyl-monoaryl moieties.

Examples of cocatalysts are found, for example, in U.S. Pat. No. 4,631,315. A preferred cocatalyst is triphenylphosphine. The cocatalyst is used preferably in amounts in a range of 0.3-5% by weight, preferably in the range of 0.5-4% by weight, based on the weight of the nitrile rubber to be hydrogenated. It is moreover preferable that the ratio by weight of the rhodium-containing catalyst to the cocatalyst is in the range from 1:3 to 1:55, more preferably in the range from 1:5 to 1:45. Based on 100 parts by weight of the nitrile rubber to be hydrogenated, use is made suitably of 0.1 to 33 parts by weight of the cocatalyst, preferably 0.5 to 20 and very preferably 1 to 5 parts by weight, in particular more than 2 but less than 5 parts by weight of cocatalyst based on 100 parts by weight of the nitrile rubber to be hydrogenated.

The practical conduct of this hydrogenation process is well known to the skilled person from U.S. Pat. No. 6,683,136. It is typically accomplished by subjecting the nitrile rubber to be hydrogenated to the action of hydrogen, in a solvent such as toluene or monochlorobenzene, at a temperature in the range from 100° C. to 150° C. and at a pressure in the range from 50 to 150 bar for 2 to 10 h.

Hydrogenation for the purposes of this invention is a reaction of the double bonds present in the initial nitrite rubber to an extent of at least 50%, preferably 70-100%, particularly preferably 80-100% and in particular 90-100%.

When heterogeneous catalysts are used, these usually involve supported catalysts based on palladium and supported by way of example on carbon, on silica, on calcium carbonate or on barium sulphate.

In particular in the case of embodiment (2) of the process according to the invention, it is possible, by virtue of the opportunity of using the RAFT regulator to control the molar mass of the resultant polymer, to produce NBR grades (and also HNBR grades correspondingly in the case of additional downstream hydrogenation) with low molar mass and low Mooney viscosity, without any need, in the case of the HNBR, for essential targeted molar-mass degradation (e.g. through mastication, chemical degradation or metathesis) in another step prior to the hydrogenation process. Additional molar-mass degradation of this type can of course take place if desired, in particular through the metathesis known to the person skilled in the art by way of example from WO-A-02/100941 and WO-A-021100905.

On the basis of the nitrile rubbers obtained by way of the process according to the invention, or of the corresponding optionally hydrogenated nitrile rubbers, it is also possible to produce vulcanizable mixtures comprising the optionally hydrogenated nitrile rubber, at least one crosslinking agent and optionally at least one filler.

Vulcanizable mixtures of this type can also optionally comprise one or more additives which are familiar to the person skilled in the art for use in rubbers. These comprise ageing inhibitors, reversion stabilizers, light stabilizers, antiozonants, processing aids, plasticizers, mineral oils, tackifiers, blowing agents, dyes, pigments, waxes, resins, extenders, organic acids, vulcanization retarders, metal oxides, and other filler activators, for example triethanolamine, trimethylolpropane, polyethylene glycol, hexanetriol, aliphatic trialkoxysilanes or other additives known in the rubber industry (Ullmann's Encyclopedia of Industrial Chemistry, VCH Verlagsgesellschaft mbH, D-69451 Weinheim, 1993, Vol. A 23 “Chemicals and Additives”, pp. 366-417).

Crosslinking agents that can be used comprise by way of example peroxidic crosslinking agents, such as bis(2,4-dichlorobenzoyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)hex-3-yne.

It can be advantageous in addition to these peroxidic crosslinking agents to use other additives as well that can be employed to help increase the crosslinking yield: suitable examples of such additives include triallyl isocyanurate, triallyl cyanurate, trimethylolpropane tri(meth)acrylate, triallyl trimellitate, ethylene glycol dimethacrylate, butanediol dimethacrylate, trimethylolpropane trimethacrylate, zinc acrylate, zinc diacrylate, zinc methacrylate, zinc dimethacrylate, 1,2-polybutadiene or N,N′-m-phenylenedimaleimide.

The total amount of the crosslinking agent or crosslinking agents is typically in the range from 1 to 20 phr, preferably in the range from 1.5 to 15 phr and more preferably in the range from 2 to 10 phr, based on the optionally hydrogenated nitrile rubber.

Crosslinking agent used can also comprise sulphur in elemental soluble or insoluble form, or sulphur donor.

Sulphur donors that can be used comprise by way of example dimorpholyl disulphide (DTDM), 2-morpholinodithiobenzothiazole (MBSS), caprolactam disulphide, dipentamethylenethiuram tetrasulphide (DPTT), and tetramethylthiuram disulphide (TMTD).

Again in the case of sulphur vulcanization of the nitrile rubbers according to the invention, it is also possible to use other additives which can be used to increase crosslinking yield. However, the crosslinking process can in principle also take place with sulphur or sulphur donors alone.

Conversely, however, the crosslinking of the optionally hydrogenated nitrile rubbers according to the invention can also take place only in the presence of the abovementioned additives, i.e. without addition of elemental sulphur or of sulphur donors.

Examples of suitable additives which can be used to increase crosslinking yield are dithiocarbamates, thiurams, thiazoles, sulphenamides, xanthogenates, guanidine derivatives, caprolactams and thiourea derivatives.

Dithiocarbamates that can be used comprise by way of example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams which can be used comprise by way of example: tetramethylthiuram disulphide (TMTD), tetramethylthiuram monosulphide (TMTM), dimethyldiphenylthiuram disulphide, tetrabenzylthiuram disulphide, dipentamethylenethiuram tetrasulphide and tetraethylthiuram disulphide (TETD).

Thiazoles which can be used comprise by way of example: 2-mercaptobenzothiazole (MBT), dibenzothiazyl disulphide (MBTS), zinc mercaptobenzothiazole (ZMBT) and copper 2-mercaptobenzothiazole.

Sulphenamide derivatives which can be used include, for example, the following: N-cyclohexyl-2-benzothiazylsulphenamide (CBS), N-tert-butyl-2-benzothiazylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-butylsulphenamide and oxydiethylenethiocarbamyl-N-oxyethylenesulphenamide.

Xanthogenates which can be used include, for example, the following: sodium dibutylxanthogenate, zinc isopropyldibutylxanthogenate and zinc dibutylxanthogenate.

Guanidine derivatives which can be used include, for example, the following: diphenylguanidine (DPG), di-o-tolylguanidine (DOTG) and o-tolylbiguanidine (OTBG).

Dithiophosphates which can be used include, for example, the following: zinc dialkyldithiophosphates (chain length of the alkyl moieties C2 to C16), copper dialkyldithiophosphates (chain length of the alkyl moieties C₂ to C₁₆) and dithiophosphoryl polysulphide.

The caprolactam used can comprise by way of example dithiobiscaprolactam.

Thiourea derivatives used can comprise by way of example N,N′-diphenylthiourea (DPTU), diethylthiourea (DETU) and ethylenethiourea (ETU).

Examples of other suitable additives are: zinc diamine diisocyanate, hexamethylenetetramine, 1,3-bis(citraconimidomethyl)benzene and cyclic disulphanes.

The abovementioned additives, and also the crosslinking agents, can be used either individually or else in mixtures. It is preferable to use the following substances for crosslinking the nitrile rubbers: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and the abovementioned additives may be used in each case in amounts of about 0.05 to 10 phr, preferably 0.1 to 8 phr, more particularly 0.5 to 5 phr (individual metered addition, based in each case on the active substance) relative to the optionally hydrogenated nitrile rubber.

In the case of sulphur crosslinking according to the invention, it may also be sensible, in addition to the crosslinking agents and abovementioned additives, to use further organic and/or inorganic substances as well, examples being the following: zinc oxide, zinc carbonate, lead oxide, magnesium oxide, calcium oxide, saturated or unsaturated organic fatty acids and their zinc salts, polyalcohols, amino alcohols, e.g. triethanolamine, and also amines, e.g. dibutylamine, dicyclohexylamine, cyclohexylethylamine and polyetheramines.

Where the optionally hydrogenated nitrile rubbers according to the invention are rubbers with repeat units of one or more carboxyl-containing termonomers, crosslinking may also take place via the use of a polyamine crosslinking agent, preferably in the presence of a crosslinking accelerator. There is no restriction on the polyamine crosslinking agent, provided that it is (1) a compound which contains either two or more amino groups (optionally also in salt form) or (2) a species which during the crosslinking reaction, in situ, forms a compound which forms two or more amino groups. Preference is given to using an aliphatic or aromatic hydrocarbon compound in which at least two hydrogen atoms are replaced either by amino groups or else by hydrazide structures (the latter being a structure “—C(═O)NHNH₂”).

Examples of polyamine crosslinking agents (ii) of this kind are as follows:
Aliphatic polyamines, preferably hexamethylenediamine, hexamethylenediamine carbamate, tetramethylenepentamine, hexamethylenediamine-cinnamaldehyde adduct or hexamethylenediamine dibenzoate;
Aromatic polyamines, preferably 2,2-bis(4-(4-aminophenoxy)phenyl)propane, 4,4′-methylenedianiline, m-phenylenediamine, p-phenylenediamine or 4,4′-methylenebis(o-chloroaniline);
Compounds having at least two hydrazide structures, preferably isophthalic dihydrazide, adipic dihydrazide or sebacic dihydrazide.

Particularly preferred are hexamethylenediamine and hexamethylenediamine carbamate.

The amount of the polyamine crosslinking agent in the vulcanizable mixture is usually in the range from 0.2 to 20 parts by weight, preferably in the range from 1 to 15 parts by weight and particularly preferably in the range from 1.5 to 10 parts by weight, based on 100 parts by weight of the optionally hydrogenated nitrile rubber,

Crosslinking accelerator used in combination with the polyamine crosslinking agent can comprise any crosslinking accelerator known to the person skilled in the art, preferably a basic crosslinking accelerator. Examples of those that can be used are tetramethylguanidine, tetraethylguanidine, diphenylguanidine, di-o-tolylguanidine (DOTG), o-tolylbiguanidine and di-o-tolylguanidine salt of dicatecholboric acid. It is also possible to use aldehyde-amine crosslinking accelerators, such as n-butylaldehyde-aniline. It is particularly preferable that crosslinking accelerator used comprises at least one bi- or polycyclic aminic base. These are known to the person skilled in the art, The following are in particular suitable: 1,8-diazabicyclo[5.4.0]undec-7-ene (DBU), 1,5-diaza-) bicyclo[4.3.0]-5-nonene (DBN), 1,4-diazabicyclo[2.2.2]octane (DABCO), 1,5,7-triazabicyclo[4.4.0]dec-5-ene (TBD), and 7-methyl-1,5,7-triazabicyclo[4.4.0]dec-5-ene (MTBD).

In this case, the amount of the crosslinking accelerator is usually in the range from 0.5 to 10 parts by weight, preferably from 1 to 7.5 parts by weight, in particular from 2 to 5 parts by weight, based on 100 parts by weight of the optionally hydrogenated nitrile rubber.

The vulcanizable mixture based on the optionally hydrogenated nitrile rubber according to the invention can in principle also comprise vulcanization-onset retarders. Among these are cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

The optionally hydrogenated nitrile rubber according to the invention can also be mixed with other conventional rubber additives, alongside the addition of the crosslinking agent(s).

Fillers which can be used comprise by way of example carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), or silicates.

Suitable filler activators comprise in particular organic silanes, such as, for example, vinyltrimethyloxysilane, vinyldimethoxymethylsilane, vinyltriethoxysilane, vinyltris(2-methoxy-ethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyl-trimethoxysilane or (octadecyl)methyldimethoxysilane. Other filler activators are by way of example surfactant substances, such as triethanolamine and ethylene glycols having molar masses of from 74 to 10 000 g/mol. The amount of filler activators is usually from 0 to 10 phr, based on 100 phr of the optionally hydrogenated nitrile rubber.

As ageing inhibitors it is possible to add to the vulcanizable mixtures ageing inhibitors known from the literature. These inhibitors are used typically in amounts of about 0 to 5 phr, preferably 0.5 to 3 phr, per 100 phr of the optionally hydrogenated nitrile rubber.

Suitable phenolic ageing inhibitors are alkylated phenols, styrenized phenol, sterically hindered phenols such as 2,6-di-tert-butylphenol, 2,6-di-tert-butyl-p-cresol (BHT), 2,6-di-tert-butyl-4-ethylphenol, sterically hindered phenols containing ester groups, thioether-containing sterically hindered phenols, 2,2′-methylenebis(4-methyl-6-tert-butylphenol) (BPH) and also sterically hindered thiobisphenols.

If discolouration of the nitrile rubber is not important, aminic ageing inhibitors are also used, examples being mixtures of diaryl-p-phenylenediamines (DTPD), octylated diphenylamine (ODPA), phenyl-α-naphthylamine (PAN), phenyl-β-naphthylamine (PBN), preferably those based on phenylenediamine. Examples of phenylenediamines are N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) and N,N′-bis-1,4-(1,4-dimethylpentyl)-p-phenylenediamine (77PD).

Among the other ageing inhibitors are phosphites such as tris(nonylphenyl) phosphite, polymerized 2,2,4-trimethyl-1,2-dihydroquinoline (TMQ), 2-mercaptobenzimidazole (MBI), methyl-2-mercaptobenzimidazole (MMBI), zinc methylmercaptobenzimidazole (ZMMBI). The phosphites are used generally in combination with phenolic ageing inhibitors. TMQ, MBI and MMBI are used especially when vulcanization takes place peroxidically.

Mould-release agents that can be used comprise by way of example: saturated or partly unsaturated fatty acids and oleic acids and their derivatives (fatty acid esters, fatty acid salts, fatty alcohols, fatty acid amides), which are preferably used as a constituent of the mixture, and also products which can be applied to the mould surface, such as, for example, products based on low molecular mass silicone compounds, products based on fluoropolymers, and products based on phenolic resins.

The amounts used of the mould-release agents as mixture constituent are about 0 to 10 phr, preferably from 0.5 to 5 phr, based on 100 phr of the optionally hydrogenated nitrile rubber.

Reinforcement with reinforcing agents (fibres) made of glass, in accordance with the teaching of U.S. Pat. No. 4,826,721 is also possible, as also is reinforcement by cords, textiles, or fibres made of aliphatic or aromatic polyamides (Nylon®, Aramid®), or of polyesters or of natural-fibre products.

The abovementioned vulcanizable mixtures can be used in the next step to produce vulcanisates, in that the vulcanizable mixture is subjected to a crosslinking process. The crosslinking is typically brought about either by at least one crosslinking agent or else by photochemical activation.

In the case of photochemically activated vulcanization, UV activators that can be used comprise those usually known to the person skilled in the art, for example benzophenone, 2-methylbenzophenone, 3,4-dimethylbenzophenone, 3-methylbenzophenone, 4,4′-bis(diethyl-amino)benzophenone, 4,4′-dihydroxybenzophenone, 4,4′-bis[2-(1-propenyl)phenoxy]-benzophenone, 4-(diethylamino)benzophenone, 4-(dimethylamino)benzophenone, 4-benzoylbiphenyl, 4-hydroxybenzophenone, 4-methylbenzophenone, benzophenone-3,3′,4,4′-tetracarboxylic dianhydride, 4,4′-bis(dimethylamino)benzophenone, acetophenone, 1-hydroxycyclohexyl phenyl ketone, 2,2-diethoxyacetophenone, 2,2-dimethoxy-2-phenylacetophenone, 2-benzyl-2-(dimethylamino)-4′-morpholinobutyrophenone, 2-hydroxy-2-methylpropiophenone, 2-hydroxy-4′-(2-hydroxyethoxy)-2-methylpropiophenone, 3′-hydroxyacetophenone, 4′-ethoxyacetophenone, 4′-hydroxyacetophenone, 4′-phenoxyacetophenone, 4′-tert-butyl-2′,6′-dimethylacetophenone, 2-methyl-4′-(methylthio)-2-morpholinopropiophenone, diphenyl(2,4,6-trimethylbenzoyl)phosphine oxide, phenylbis(2,4,6-trimethylbenzoyl)phosphine oxide, methyl benzoylformate, benzoin, 4,4′-dimethoxybenzoin, benzoin methyl ether, benzoin ethyl ether, benzoin isopropyl ether, benzoin isobutyl ether, 4,4′-dimethylbenzil, hexachlorocyclopentadienes or a combination thereof.

The vulcanization process usually takes place in the context of a shaping process, preferable with use of an injection-moulding process.

The invention therefore also provides the specific moulding obtainable through the abovementioned vulcanization process. It is possible to produce a wide variety of mouldings, such as, for example, seals, caps, hoses or membranes. It is possible, for example, to produce O-ring seals, flat seals, corrugated gaskets, sealing sleeves, sealing caps, dust protection caps, plug seals, thermal insulation hoses (with and without addition of PVC), oil cooler hoses, air intake hoses, servocontrol hoses or pump diaphragms.

### EXAMPLES

In the examples below, it was possible to show that the use of solvent mixtures leads, in comparison with pure solvents, to an increase in conversion without any sacrifices in terms of molar mass, in defined times. The conversions in the polymerization processes were determined gravimetrically.

The purity levels of the synthesis chemicals used are as follows:

acrylonitrile (+99%, Acros) and 1,3-butadiene (>99.5%, Air Liquide), and 2,2′-azobis(N-butyl-2-methylpropionamide) (Vam 110, Wako Pure Chemical Industries Ltd) were used as obtained. The molar-mass regulator tert-dodecyl mercaptan was obtained from Lanxess Deutschland GmbH. 1,4-Dioxane (>99.8%) and toluene (>99.8%) were obtained from VWR. N,N-Dimethylacetamide (DMAc, >99.5%), monochlorobenzene (>99%) and acetonitrile (>99%) were obtained from Acros Organics. tert-Butanol (99%) was obtained from ABCR. The solvents used were used directly without further purification.

Unless otherwise stated, the chemicals listed in the tables were purchased by way of the chemicals market or from the applicant's production plants. The “DoPAT” regulator used (dodecylpropanoic acid trithiocarbonate as depicted in the formula below) was synthesized in the laboratory in accordance with the production process described in Macromolecules (2005), 38 (6), 2191-2204.

### Molar Masses and Polydispersity Index:

The molar masses in the form of number-average molar mass (Mₙ) and of weight-average molar mass (KO, and the polydispersity index, were determined by means of gel permeation chromatography (GPC) in accordance with DIN 55672-1 (Part 1: Tetrahydrofuran THF as solvent).

### Examples 1-14 (According to the Invention and Comparative Examples)

### Production of Nitrile Rubbers (“NBR”) in Various Organic Solvents and Mixtures of Organic Solvents with Different Ratios

The nitrile rubbers NBR #1 to #14 used in the series of examples below were produced in accordance with the parent formulation stated in Table 1, where the values stated for all of the starting materials are in parts by weight, based on 100 parts by weight of the monomer mixture. Table 1 also specifies the respective polymerization conditions.

All of the apparatuses were rendered oxygen-free by three cycles of evacuation and nitrogen-flushing prior to contact with 1,3-butadiene.

The polymerization procedure in Example 1 was as follows:

273.7 mg of Vam 110 (0.88 mmol, corresponding to 0.38 phm) and 61.4 mg of DoPAT (0.175 mmol, corresponding to 0.086 phm) were dissolved in 90 ml (139 phm) of monochlorobenzene and 5 ml (6.6 phm) of dimethylacetamide, 31.7 ml of acrylonitrile (481.5 mmol, corresponding to 36 phm) were added, and the mixture was degassed with nitrogen for 10 minutes. The monomer/initiator solution was transferred to the reactor, and this was sealed and rendered oxygen-free by three cycles of evacuation/flushing with nitrogen. 70.5 ml of 1,3-butadiene (847.2 mmol, corresponding to 64 phm) are metered into the mixture by way of a pressurized burette, and the reaction is initiated through heating to 100° C. The course of the polymerization process was followed by gravimetric determinations of conversion. After 22 hours, the heating source was removed, excess 1,3-butadiene was removed by aerating after cooling of the reactor, and the polymer was obtained by precipitation in ethanolic solution. The polymer was then dried in a high vacuum.

The polymerization processes of Examples 2 to 10 were carried out analogously, while varying the amount of the regulator and of the initiator, and also the nature of the solvent (see Table 1). Examples 8-11 and Example 13 are comparative examples in which the polymerization process was carried out in a pure solvent. Example 14 is a comparative example in which the polymerization process was carried out in a mixture of monochlorobenzene and dimethylacetamide, but where the content of the main solvent was only 60% by volume, based on the total solvent volume. To the extent that the polymerization conditions deviated from those in Example 1, this has likewise been listed in Table 1.

TABLE 1
Examples 1-14
Formulations and polymerization conditions
Unless otherwise stated, all data relating to the constituents in the polymerization formulation are in phm
(parts per hundred of monomer)

| Name: | NBR 1 | NBR 2 | NBR 3 | NBR 4 | NBR 5 | NBR 6 | NBR 7 | NBR 8 | NBR 9 | NBR 10 | NBR 11 | NBR 12 | NBR 13 | NBR 14 |
|---|---|---|---|---|---|---|---|---|---|---|---|---|---|---|
| Acrylonitrile | 36 | 36 | 36 | 36 | 36 | 36 | 36 | 36 | 36 | 36 | 35 | 35 | 36 | 36 |
| Butadiene | 64 | 64 | 64 | 64 | 64 | 64 | 64 | 64 | 64 | 64 | 65 | 65 | 64 | 64 |
| Solvent 1 | | | | | | | | | | | | | | |
| Monochloro- | 144 | 139 | 100 | 139 | 139 | 139 | 139 | — | 146 | — | 147 | 140 | — | 88 |
| benzene | | | | | | | | | | | | | | |
| Solvent 2 | | | | | | | | | | | | | | |
| Dimethyl- | 2.6 | 6.6 | 39.4 | — | — | — | — | — | — | 125 | — | 7 | 122 | 50 |
| acetamide | | | | | | | | | | | | | | |
| Toluene | — | — | — | 6.1 | — | — | — | — | — | — | — | — | — | — |
| 1,4-Dioxane | — | — | — | — | 7.2 | — | — | — | — | — | — | — | — | — |
| Acetonitrile | — | — | — | — | — | 5.5 | — | — | — | — | — | — | — | — |
| Tert-Butanol | — | — | — | — | — | — | 5.4 | 103 | — | — | — | — | — | — |
| Ratio by | | | | | | | | | | | | | | |
| volume | | | | | | | | | | | | | | |
| Solvent | 97.9:2.1 | 94.7:5.3 | 70:30 | 94.7:5.3 | 94.7:5.3 | 94.7:5.3 | 94.7:5.3 | 0:100 | 100:0 | 0:100 | 100:0 | 94.7:5.3 | 0:100 | 60:40 |
| 1:Solvent | | | | | | | | | | | | | | |
| 2: | | | | | | | | | | | | | | |
| VAm ® 110 | 0.38 | 0.38 | 0.38 | 0.38 | 0.38 | 0.38 | 0.38 | 0.38 | 0.38 | 0.38 | 0.38 | 0.39 | 0.39 | 0.38 |
| DoPAT | 0.086 | 0.086 | 0.086 | 0.086 | 0.086 | 0.086 | 0.086 | 0.086 | 0.086 | 0.086 | — | — | — | 0.086 |
| TDM | — | — | — | — | — | — | — | — | — | — | 0.23 | 0.23 | 0.23 | — |
| Reaction | | | | | | | | | | | | | | |
| conditions | | | | | | | | | | | | | | |
| Polymerization | 100 | 100 | 100 | 100 | 100 | 100 | 100 | 100 | 100 | 100 | 100 | 100 | 100 | 100 |
| temperature | | | | | | | | | | | | | | |
| (° C.) | | | | | | | | | | | | | | |
| Polymerization | 22 | 22 | 22 | 22 | 22 | 22 | 22 | 22 | 22 | 22 | 22 | 22 | 22 | 22 |
| time (h) | | | | | | | | | | | | | | |

where:
Vam ® 110: 2,2′-Azobis(N-butyl-2-methylpropionamide) (Wako)

TABLE 2
Analytical results for Examples 1-14

| Analysis: | NBR 1 | NBR 2 | NBR 3 | NBR 4 | NBR 5 | NBR 6 | NBR 7 | NBR 8 | NBR 9 | NBR 10 | NBR 11 | NBR 12 | NBR 13 | NBR 14 |
|---|---|---|---|---|---|---|---|---|---|---|---|---|---|---|
| Final | 21.2 | 22.7 | 25.0 | 20.1 | 22.5 | 19.8 | 22.3 | 21.2 | 18.4 | 28.3 | 18.0 | 20.9 | 32.8 | 22.3 |
| conversion (%) | | | | | | | | | | | | | | |
| Mn (kg/mol) | 117 | 98 | 90 | 88 | 89 | 86 | 100 | 79 | 99 | 91 | 86 | 86 | 80 | 57 |
| Mw (kg/mol) | 240 | 181 | 169 | 165 | 168 | 156 | 197 | 138 | 181 | 175 | 174 | 173 | 168 | 104 |
| PDI | 2.06 | 1.86 | 1.87 | 1.86 | 1.90 | 1.81 | 1.96 | 1.74 | 1.83 | 1.93 | 2.01 | 2.03 | 2.10 | 1.8 |

where
Mₙ = number-average molar mass
M_{w} = weight-average molar mass
PDI = polydispersity index, being quotient calculated from M_{w} and Mₙ

The favourable, non-linear effect of an additional solvent on conversion in the polymerization process, with non of the resultant possible disadvantages in terms of molar mass, can be clearly discerned from Comparative Examples 9 and 10 and Examples 1-3 according to the invention. Addition of a second solvent here causes a marked increase in conversion in identical reaction times, without any adverse effect on molar mass or polydispersity. This surprising favourable effect can be observed independently of the molar-mass regulator, as is also shown by comparison between Examples 11 and 13 and Example 12 according to the invention. From Example 14, not according to the invention, with 60% by volume of monochlorobenzene, in direct comparison with Example 3 according to the invention, with 70% by volume of monochlorobenzene, it is clearly apparent that at values less than the limit of 70% by volume of the main solvent, based on the total volume of the solvents, there is a marked decrease not only in conversion but also in the molar masses Mn and Mw achievable.

What is claimed is:

1. Process for producing nitrile rubbers through free-radical polymerization of at least one conjugated diene, of at least one α,β-unsaturated nitrile and optionally of one or more other copolymerizable monomers, characterized in that at least two solvents are used, where the amount used of one solvent, known as the main solvent, is in the range from 70 to 99.9% by volume, based on the entirety of all of the solvents used.

2. Process according to claim 1, characterized in that it is carried out either
(1) in the absence of any molar-mass regulator, or
(2) in the presence of a compound of the general structural formula (VI) 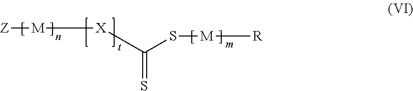
in which
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
R (a) if m≠0, has the same meanings as the moiety Z and
(b) if m=0, is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0, and
X is C(Z₂), N(Z), P(Z), P(═O)(Z), O, S, S(═O) or S(═O)₂, where Z in these moieties can have the meanings stated previously for the formula (VI), or
(3) in the presence of a compound selected from the group consisting of
(i) mercaptans which comprise at least one SH group,
(ii) mercapto alcohols which comprise at least one SH group and at least one OH group,
(iii) mercaptocarboxylic acids which comprise at least one SH group and at least one carboxy group, and mercaptocarboxylic esters which comprise at least one SH group and at least one carboxylic ester group,
(iv) thiocarboxylic acids,
(v) disulphides, polysulphides,
(vi) thiourea,
(vii) allyl compounds,
(viii) aldehydes,
(ix) aliphatic halohydrocarbons, araliphatic halohydrocarbons
(x) saccharin and
(xi) any desired mixtures of two or more of the abovementioned molar-mass regulators (i)-(x).

3. Process according to claim 2, where a regulator is used that has been selected from the group consisting of
(i) regulators of the general formula (VIa), 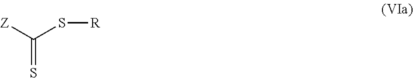
in which
Z has any of the meanings specified for the general formula (VI) in claim 1 and
R has the meanings specified for the general formula (VI) in claim 1 for the variant b) where m=0,
(ii) regulators of the general formula (VIb) 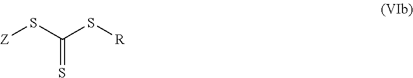
in which
Z has the meanings previously specified for the general formula (VI) in claim 1,
R has the meanings previously specified for the general formula (VI) in claim 1 for the variant b) where m=0 but with the restriction that, after homolytic cleavage of the S—R bond, R forms either a secondary, tertiary or aromatically stabilized free radical,
(iii) regulators of the general formula (VIc) 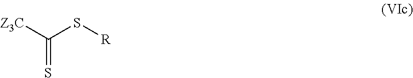
in which
Z has the meanings specified for the general formula (VI) in claim 1,
R has the meanings specified for the general formula (VI) in claim 1 for the variant b) where m 0 but with the restriction that, after homolytic cleavage of the S—R bond, R forms either a secondary, tertiary or aromatically stabilized free radical,
(iv) regulators of the general formula (VId) 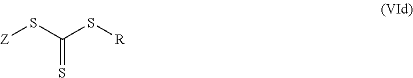
in which
Z has the meanings specified for the general formula (VI) in claim 1, but with the restriction that, after homolytic cleavage of the S—Z bond, Z forms a primary free radical, and
R has the same meanings as Z in claim 1, but with the restriction that, after homolytic cleavage of the S—R bond, R forms either a secondary, tertiary or aromatically stabilized free radical, and
with the additional proviso that Z and R assume different meanings, and
(v) regulators of the general formula (VIe) 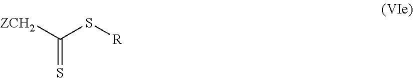
in which
Z has the meanings specified for the general formula (VI) in claim 1 and
R has the same meanings as Z in claim 1, but with the restriction that, after homolytic cleavage of the S—R bond, R forms either a secondary, tertiary or aromatically stabilized free radical.

4. Process according to claim 3, where regulator used comprises dodecylpropanoic acid trithiocarbonate (DoPAT), dibenzoyl trithiocarbonate (DiBenT), cumyl phenyl dithioacetate (CPDA), cumyl dithiobenzoate, phenyl ethyl dithiobenzoate, cyanoisopropyl dithiobenzoate (CPDB), 2-cyanopropyl dodecyl trithiocarbonate, 2-cyanoethyl dithiobenzoate, 2-cyanoprop-2-yl dithiophenylacetate, 2-cyanoprop-2-yl dithiobenzoate, S-thiobenzoyl-1H,1H, 2-keto-3-oxa-4H,4H,5H,5H-perfluoroundecanethiol or S-thiobenzoyl-1-phenyl-2-keto-3-oxa-4H,4H,5H,5H-perfluoroundecanethiol.

5. Process according to claim 2, where the molar-mass regulator has been selected from the group consisting of
(i) alkyl mercaptans, preferably C₁-C₁₆ alkyl mercaptans, in particular methyl mercaptan, ethyl mercaptan, n-butyl mercaptan, n-hexyl mercaptan, n-octyl mercaptan, n-dodecylmercaptan, tert-nonyl mercaptan and tert-dodecyl mercaptans,
(ii) aliphatic mercapto alcohols and cycloaliphatic mercapto alcohols, preferably 2-mercapto-1-ethanol, 3-mercapto-1-propanol, 3-mercaptopropane-1,2-diol, 4-mercapto-1-butanol and 2-mercaptocyclohexanol,
(iii) mercaptoacetic acid, 3-mercaptopropionic acid, mercaptobutanedioic acid, cysteine, N-acetylcysteine and alkyl thioglycolates, in particular ethylhexyl thioglycolate,
(iv) thioacetic acid,
(v) xanthogen disulphides, preferably diisopropylxanthogen disulphide,
(vi) thiourea
(vii) allyl alcohol, allyl chloride,
(viii) crotonaldehyde,
(ix) chloroform, carbon tetrachloride, iodoform, benzyl bromide and
(x) saccharin, and
(xi) any desired mixtures of two or more of the molar-mass regulators (i)-(x).

6. Process according to any of claims 1 to 5, where the polymerization uses one or more initiators selected from the group consisting of peroxidic initiators, azo initiators and redox systems, or takes place through photochemical initiation.

7. Process according to any of claims 1 to 6, where the polymerization uses an azo initiator of the following structural formulae (Ini-1) to (Ini-6)

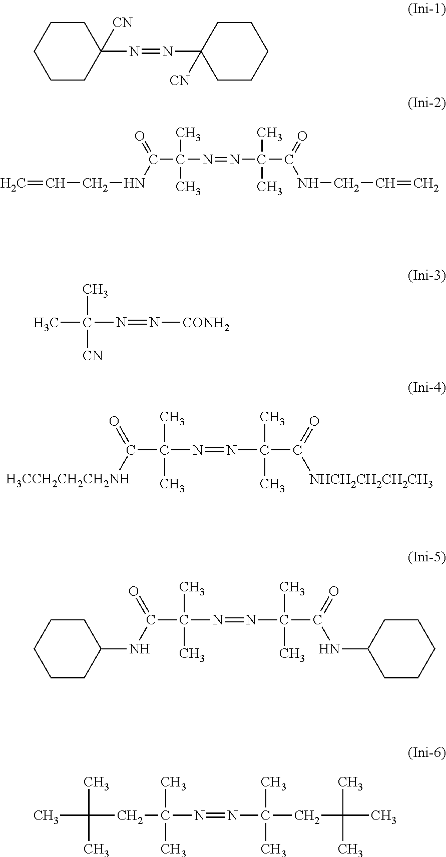

8. Process according to any of claims 1 to 7, characterized in that the amount used of the main solvent is in the range from 75 to 99.9% by volume, particularly from 85 to 99.5% by volume, based on the entirety of all of the solvents used, and the total amount used of the other solvent(s) is from 0.1 to 25% by volume, particularly from 0.5 to 15% by volume, again based on the entirety of all of the solvents used.

9. Process according to any of claims 1 to 8, characterized in that main solvents used are those which have a Hildebrand solubility parameter δ (δ=((ΔHᵥ−RT)/Vₘ)^{1/2} [(MPa)^{1/2}] (Vₘ=molar volume; ΔH_{V}=enthalpy of vaporization; R=ideal gas constant)) in the range from 15.5 to 26 (MPa)^{1/2}, preferably in the range from 16 to 25 (MPa)^{1/2}.

10. Process according to any of claims 1 to 9, characterized in that main solvent used comprises a solvent selected from the group consisting of dimethylacetamide, monochlorobenzene, toluene, ethyl acetate, 1,4-dioxane, acetonitrile, tert-butanol, tea-butyl nitrile, dimethyl carbonate, methyl acetate, isobutyronitrile and acetone, and one or more other solvents different from the main solvent and selected from the group consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tea-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol and methanol.

11. Process according to any of claims 1 to 9, characterized in that main solvent used comprises monochlorobenzene in combination with one or more, preferably one, other solvent(s) selected from the group consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol, methanol, isobutyronitrile, dimethyl carbonate, trimethylacetonitrile, and methyl acetate.

12. Process according to any of claims 1 to 9, characterized in that main solvent used comprises monochlorobenzene and additional solvent used comprises N,N-dimethylacetamide.

13. Process according to any of claims 1 to 9, characterized in that main solvent used comprises a solvent selected from the group consisting of tert-butanol, 1,4-dioxane, acetonitrile, toluene, isobutyronitrile, isopropyl methyl ketone, N,N-dimethylacetamide, dimethyl carbonate, trimethylacetonitrile, and methyl acetate, and an additional solvent used comprises one selected from the group differing from the main solvent and consisting of water, diisopropyl ether, di-n-propyl ether, diethyl carbonate, isopropyl methyl ketone, butyl acetate, octanoic acid, isopropyl acetate, propyl acetate, pivalonitrile, toluene, methyl tert-butyl ether, 1-butanol, 2-ethoxyethanol, phenoxyethanol, 2-propanol, benzyl alcohol, 1-propanol, 2-methoxymethanol, N,N-dimethylformamide, ethanol, 1,3-butanediol, diethylene glycol, methanol, isobutyronitrile, dimethyl carbonate, trimethylacetonitrile, and methyl acetate.

14. Process according to any of claims 1 to 13, characterized in that the free-radical polymerization process is followed by hydrogenation.

15. Process for producing vulcanisates, characterized in that the optionally hydrogenated nitrile rubber is subjected, after the process for producing the same according to any of claims 1 to 14, to crosslinking, preferably through addition of at least one crosslinking agent or through photochemical activation, particularly preferably with addition of one or more other additives.
